(19) United States
(12) Patent Application Publication
(10) Pub. No.: US 2011/0029869 A1
(43) Pub. Date: Feb. 3, 2011

(54) METHOD AND SYSTEM RESPONSIVE TO INTENTIONAL MOVEMENT OF A DEVICE

(76) Inventor: Hamish McLennan, Repton (AU)

Correspondence Address: Christopher C. Dremann, P.C., 8116 South Tryon Street, Suite B-3, Box 261, Charlotte, NC, 28273, US

(21) Appl. No.: 12/920,159

(22) PCT Filed: Feb. 27, 2009
(86) PCT No.: PCT/AU09/00224

§ 371 Date: Aug. 30, 2010

Related U.S. Application Data
(60) Provisional application No. 61/032,808, filed on Feb. 29, 2008.

(30) Foreign Application Priority Data
Feb. 29, 2008 (AU) 2008901010

(51) Int. Cl. G06F 3/01

(52) U.S. Cl. 715/702

(57) ABSTRACT

A method for causing an action to be performed in a device, the method including the steps of in a processing system of the device, receiving an indication of movement of at least a portion of the device, the movement being associated with an action option, and causing the action to be performed in respect of the movement.

### FIELD OF THE INVENTION

The present invention relates to a method and system for causing an action to be performed, and in particular, causing the action to be performed in a device, and in one particular example, a hand-held device such as a mobile telecommunications device, or the like.

### DESCRIPTION OF THE BACKGROUND ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

Presently, devices such as hand-held items including mobile phones, or the like, typically include buttons which a user of the device can use to enter information into the device. However, when writing a text message on the phone, for example, it is sometimes an arduous process to type an entire message, and errors are often made. Furthermore, typing data into a device can often be time consuming and hence may not be efficient in emergency situations.

There is required a system and/or method for causing an action to be performed, and in particular, causing an action to be performed which overcomes, at least ameliorates one or more disadvantages of existing arrangements, or provides an alternative to existing arrangements.

### SUMMARY OF THE PRESENT INVENTION

In a first broad form, there is provided a method for causing an action to be performed in a device, the method including the steps of, in a processing system of the device:
a) receiving an indication of movement of at least a portion of the device, the movement being associated with an action option; and,
b) causing the action to be performed in respect of the movement.

According to one example, the method includes:
a) displaying a plurality of action options; and,
b) receiving the indication of movement in a direction of at least one of the plurality of action options.

According to a further example, the method includes receiving an indication of a selection of the at least one of the plurality of action options.

According to yet another example, the indication of the selection of the at least one of the plurality of action options, includes any one or a combination of:
a) a predetermined movement;
b) crossing of a virtual boundary;
c) pressing of a key of the device; and,
d) releasing of a key of the device.

In yet a further example, the method includes generating a feedback in accordance with the received indication of selection.

According to another example, generating a feedback includes any one or a combination of:
a) vibration of the device;
b) a visual feedback; and,
c) an auditory feedback.

According to a further form, the method includes displaying the plurality of action options in a display of the processing system, the plurality of action options being angularly spaced apart from each other.

In yet another aspect, the method includes displaying the plurality of action options around a circle or a clock-face arrangement around the display.

According to another example, the method includes displaying the plurality of action options along a path.

In a further example, the display of the plurality of action options is predetermined.

According to another aspect, the action option includes any one or a combination of:
a) text selection;
b) character selection;
c) sentence selection;
d) mode selection; and,
e) operational/functional selection.

In yet a further form, the indication of movement includes any one or a combination of:
a) indication of device movement according to a three-dimensional space;
b) indication of device movement in an angled directional movement;
c) indication of tilting of the device; and,
d) indication of rotating of the device.

According to another aspect, the device is any one or a combination of:
a) a hand-held device;
b) a mobile telecommunication device (phone);
c) a digital organiser;
d) a Personal Digital Assistant (PDA); and,
e) a digital music player.

According to a second broad form, there is provided a device, the device being configured to perform an action, the device including a processing system, the processing system being configured to:
a) receive an indication of movement of at least a portion of the device, the movement being associated with an action option; and,
b) cause the action to be performed in respect of the movement.

In a third broad form, there is provided a method for causing an action to be performed in a device, the method including the step of moving the device, the action being performed in accordance with device movement.

In a fourth broad form, there is provided a method of causing an action to be performed by a processing system in a hand-held device, the method including the step of moving the device, the action being performed in accordance with device movement.

In a fifth broad form, there is provided a device, where the device includes a processing system, the processing system being configured to perform an action in accordance with a movement of the device.

In a sixth broad form, there is provided a method for causing an action to be performed in a device, the method including the steps of, in a processing system of the device:
a) receiving an indication of movement in a direction of one of a plurality of action options, the direction of each of the plurality of action options being angularly displaced from the direction of each other of the plurality of action options; and,
b) causing the action to be performed in respect of the movement.

In a seventh broad form, there is provided a method for causing an action to be performed in a device, the method including the steps of:
a) moving the device in a direction of one of a plurality of action options, the direction of each of the plurality of action options being angularly displaced from the direction of each other of the plurality of action options; and,
b) causing the action to be performed in respect of the movement.

In a eighth broad form, there is provided a device/system for causing an action to be performed, the device including a processing system, the processing system being configured to:
a) receive an indication of movement in a direction of one of a plurality of action options, the direction of each of the plurality of action options being angularly displaced from the direction of each other of the plurality of action options; and,
b) cause the action to be performed in respect of the movement.

In a nineth broad form, there is provided a method for causing an action to be performed in a device, the method including the steps of, in a processing system of the device:
a) displaying a plurality of action options, each of the plurality of action options being angularly displaced from each other of the plurality of action options;
b) receiving an indication of movement in a direction of one of the plurality of action options; and,
c) causing the action to be performed in respect of the movement.

In an tenth broad form, there is provided a method of choosing/selecting text/character, the method including the steps of, in a processing system:
a) performing an action, the action triggering a selection of text/character to be displayed; and,
b) choosing/selecting text/character from the selection.

In one example, the selection displayed is based on any one or a combination of:
a) commonly used text/character; and.
b) recently used text/character.
c) Vocabulary/words of speech mode

In a eleventh broad form, there is provided a system for choosing/selecting text/character, the system including a processing system, the processing system being configured to:
a) perform an action, the action triggering a selection of text/character to be displayed; and,
b) choose/select text/character from the selection.

It will be appreciated that the broad forms of the invention may be used individually or in combination.

### BRIEF DESCRIPTION OF THE DRAWINGS

An example of the present invention will now be described with reference to the accompanying drawings, in which:

FIG. 1 is a flow diagram of an example method/process that can be utilised to embody or give effect to a particular implementation;

FIG. 2 is another flow diagram of an example method/process that can be utilised to embody or give effect to a particular implementation;

FIG. 3 is a functional block diagram of an example processing system that can be utilised to embody or give effect to a particular implementation;

FIG. 4 is an example network infrastructure that can be utilised to embody or give effect to a particular implementation;

FIG. 5 is a functional block diagram of an example processing system that can be utilised to embody or give effect to a particular embodiment;

FIGS. 6 to 9B are flow diagrams of various example method/processes that can be utilised to embody or give effect to other implementations/embodiments;

FIG. 10 is an illustration of an example mobile phone device;

FIG. 11 is another illustration of another example mobile phone device;

FIG. 12 is an illustration of an example text entry;

FIG. 13 is an illustration of an example of a key pad of a mobile phone device;

FIG. 14 is another illustration of an example mobile phone device;

FIG. 15 is another illustration of an example mobile phone device;

FIG. 16 is another illustration of an example mobile phone device;

FIG. 17 is another illustration of an example mobile phone device;

FIG. 18 is an illustration of an example of 3D movement of a device;

FIG. 19 is another illustration of an example mobile phone device;

FIG. 20 is an illustration of an example clock-face/angular displacement of characters;

FIG. 21 is another illustration of an example clock-face/angular displacement of characters;

FIG. 22 is another illustration of an example clock-face/angular displacement of characters;

FIG. 23 is another illustration of an example clock-face/angular displacement of characters;

FIG. 24 is an illustration of components of an example mobile phone device;

FIG. 25 is an illustration of an example of a mobile phone device;

FIG. 26 are illustrations of example character and word entries;

FIG. 27 is an illustration of an example of linear mass feedback;

FIG. 28 is an illustration of an example of torque-bar mass feedback;

FIG. 29 is an illustration of an example of torque-mass feedback;

FIG. 30 is an illustration of an example of vibrate-mass feedback;

FIG. 31 is another illustration of another example mobile phone device;

FIG. 32 is another illustration of another example mobile phone device;

FIG. 33 is another illustration of another example mobile phone device;

FIG. 34 is another illustration of another example mobile phone device;

FIGS. 35a and 35b is an illustration of an example of character entry on a mobile phone device;

FIGS. 36a and 36b is an illustration of an example of character entry on a mobile phone device;

FIGS. 37a and 37b is an illustration of an example of character entry on a mobile phone device;

FIGS. 38a and 38b is an illustration of an example of character entry on a mobile phone device;

FIGS. 39a and 39b is an illustration of an example of character entry on a mobile phone device;

FIG. 40 an illustration of an example of incremental text/sentence selection; and,

FIG. 41 is a an illustration of another example of character/word entry on a mobile phone device.

### DETAILED DESCRIPTION INCLUDING BEST MODE

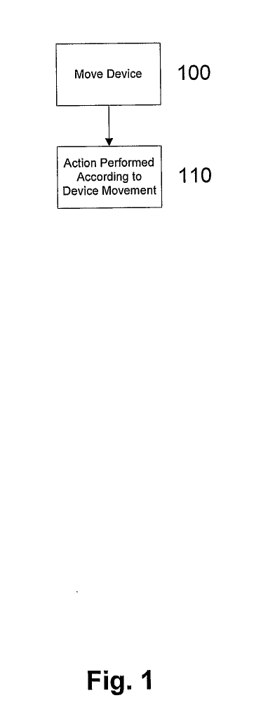

An example of a method/process for causing an action to be performed will now be described with reference to FIG. 1.

In particular, FIG. 1 shows at step 100 movement of a device, where at step 110 an action is performed according to the device movement.

Thus, according one particular example, a process for causing an action to be performed in a device, is provided herein where the method includes in a processing system of the device, receiving an indication of movement of at least a portion of the device, the movement being associated with an action option, and causing the action to be performed in respect of the movement.

It will be appreciated that the process can also include displaying a plurality of action options, and, receiving the indication of movement in a direction of at least one of the plurality of action options, as well as receiving an indication of a selection of the at least one of the plurality of action options.

According to another particular example, the indication of the selection of the at least one of the plurality of action options, can include a predetermined movement or gesture, crossing of a virtual boundary (which can be displayed in the device), pressing of a key of the device; and/or releasing of a key of the device.

Once the indication of the selection or movement is received, the process described herein can include generating a feedback in accordance with the received indication of selection. The feedback can be generated in a variety of forms, including but not limited to vibration of the device, a visual feedback (such as shown in the display), and auditory feedback (such as beep or an alert).

As described further below, the process can also include displaying the plurality of action options in a display of the processing system, where the plurality of action options being angularly spaced apart from each other. This can be in a variety of forms, including but not limited to displaying the plurality of action options around a circle or a clock-face arrangement around the display, along a path, or in a game-like fashion (which is further described below). Notably, the display of the plurality of action options can be predetermined, by either the user or manufacture. For example, a user may be able to form characters (or text) on a screen, in different directional planes, where each directional plane or a particular movement is associated with a character selection.

Thus, the indication of movement includes any one or a combination of indication of device movement according to a three-dimensional space, indication of device movement in an angled directional movement, indication of tilting of the device, and/or indication of rotating of the device.

It will also be appreciated that the action option can include any one or a combination of text selection, character selection, sentence selection; mode selection, and/or operational/functional selection of the device. Accordingly, the device can be any one or a combination of a hand-held device, a mobile telecommunication device (phone), a digital organiser, a Personal Digital Assistant (PDA), and a digital music player.

Thus, for example, the device used can be a mobile telephone device (or the like), where the device is moved such that in accordance with the particular movement, certain actions are performed by the mobile telephone, such as, for example, character entry for a short message service (SMS).

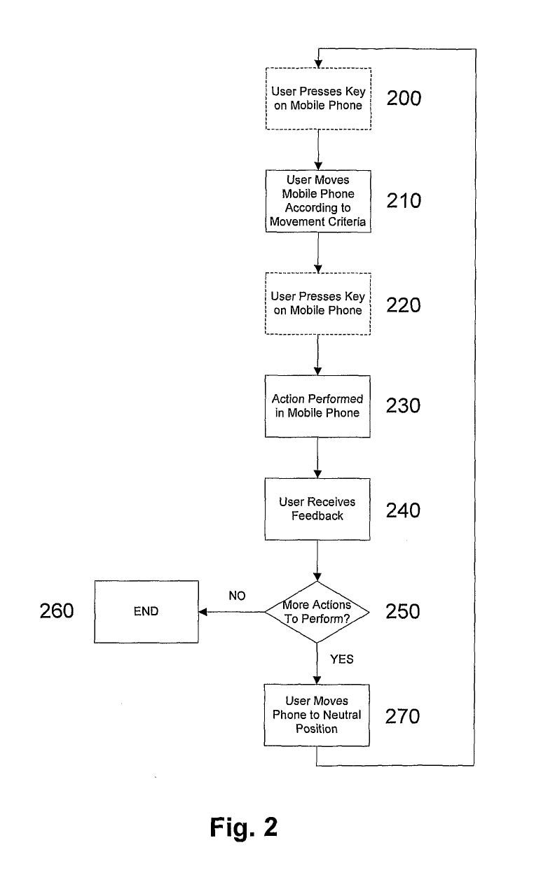

Further examples of devices and actions are described below. A particular example of a method/process for causing an action to be performed on a mobile phone is shown in FIG. 2.

FIG. 2 shows at step 200 a user optionally pressing a key on a mobile phone, where the user then moves the mobile phone according to movement criteria at step 210, depending on the action the user would like the phone to perform.

The movement criteria can include predetermined movements for particular actions. Thus, for example, if a user would like to select the SMS mode on the phone, the user may move the phone in a particular way, which then automatically selects the SMS mode on the phone. The movement can satisfy certain movement criteria which can include the direction, speed, length of movement across a boundary overtime, or the like. This movement can be pre-programmed into the mobile by the user or the manufacturer or network provider, and associated with a particular action so that upon performing the movement, the action is performed.

It will be appreciated that the action performed can include but is not limited to character entry/selection, menu navigation, text selection/entry (including word and sentence selection), activating a telephone mode (such as SMS, Internet browsing, music, camera, gaming, or the like), and any other actions that can be performed by a device (and in this particular example, a mobile phone).

At step 220, the user can then optionally press a key on the device (such as a confirmation key or a select or enter button), and at step 230 the desired action is performed in the mobile phone.

At step 240 the user can receive feedback from the mobile device in relation to the action performed. The feedback can include but is not limited to a certain character or text being displayed on the screen, a sound generated by the device, or a movement (such as a vibration) generated by the device, or a signal sent to an external device that in turn provides feedback.

At step 250 the user determines whether there are more actions to be performed. Thus, for example, if a user is using the mobile phone to write a text (SMS) message, then the movement at step 210 may have caused a character/word to be written in the text message. The user may then determine that there are more characters/words to be displayed in the text message at step 250, in which case, the process continues to step 270 where the user moves the phone to a neutral position and starts again at step 200. If the user determines that there are no further. actions, the process ends at step 260.

Notably, in this example steps 200 and 220 are optional steps. That is, depending on the action that is to be performed by the phone, this may require the user to press a key on the phone prior to moving the phone, after moving the phone, and/or during movement of the phone. This may also include the user pressing a key and releasing the key after moving the phone.

Additionally, in a further example, a user can cause the action to be performed in the device, where the device receives an indication of movement in a particular direction. The direction can form a direction, chosen by the user from a plurality of directions available, where each direction is associated with an action option. The plurality of directional movements can be angularly displaced from one another, where movement of the device in a chosen direction can cause the action to be performed.

Thus, in this particular example, the device can include a mobile phone where a user of the phone can move the phone in a plurality of directions. However, each direction can be associated with a particular action (such as, a different key selection, for example). The different directions can be angularly displaced from each other in the form of a clock or path, where movement in one direction may cause a different action to movement in another direction. The clock face arrangement of directions is described in more detail below. Thus, in this example, the movement criteria can include angular movement of the device from a neutral position in space. Notably, it will be appreciated that the term “angularly displaced” can have the various action options displaced from each other such that they form a part of a circle in a spatial plane, or such that they are spatially at an angle from each other.

It will also be appreciated that the device in/or which the action is performed can include any hand-held devices such as mobile telephones, PDAs, music players, hand-held game consoles or controls, or the like.

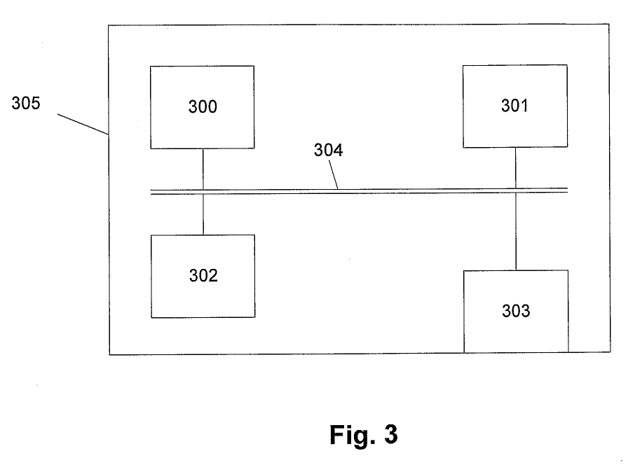

In one particular example, the device can include a processing system, an example of which is shown in FIG. 3. As shown, the processing system 305 includes a processor 300, a memory 301, an input/output device 302 such as a keyboard/keypad and display, and an external interface 303 coupled together via a bus 304, as shown.

Accordingly, it will be appreciated that the device 305 may be formed from any suitable processing system, such as a suitably programmed PC, Internet terminal, lap-top, hand-held PC, smart phone, PDA, web server, or the like, which is typically operating applications software to enable data transfer and in some cases web-browsing.

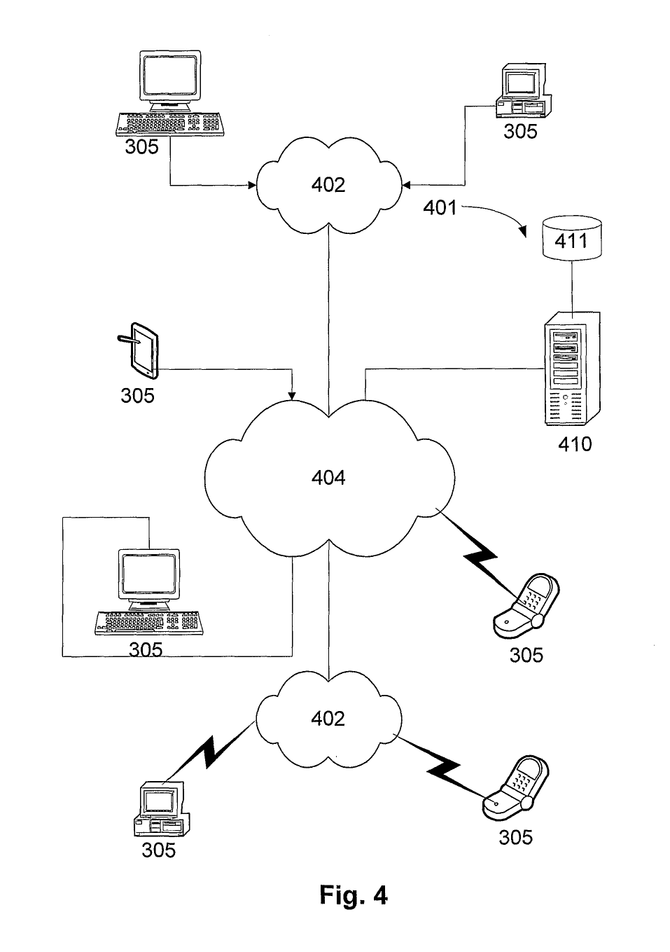

The device 305 can also include an internal interface which can allow the device 305 to be coupled to a communication network, such as the Internet or the like (examples of which include the communications networks 402, 404 as shown in FIG. 4), and accordingly, the internal interface may be in the form of a network interface card, or the like. Thus, the communication networks 402, 404 can allow the device 305 to communicate with a processing system 410 provided in a base station 401 via the communications networks 402, 404.

Thus, in one example, the device 305 is a mobile phone that can be used by a user to browse the Internet (or any network), download music/film, communicate with other users on a network, send electronic mail (Email), communicate its position to other devices, or the like, Accordingly, the process of FIG. 1 can be performed using a distributed architecture, an example of which will now be described with reference to FIG. 4.

In this example, a base station 401 is coupled to a number of end stations 305 via a communications network 402, such as the Internet, and/or via communications networks 404, such as local area networks (LANs), or wide area networks (WANs). Thus, it will be appreciated that the LANs 404 may form an internal network at a specific location.

The base station 401 typically includes one or more processing systems 410, optionally coupled to one or more databases 411. In use, the processing system 410 can be configured allow the user of the device 305 to access particular information/data stored in the database 411.

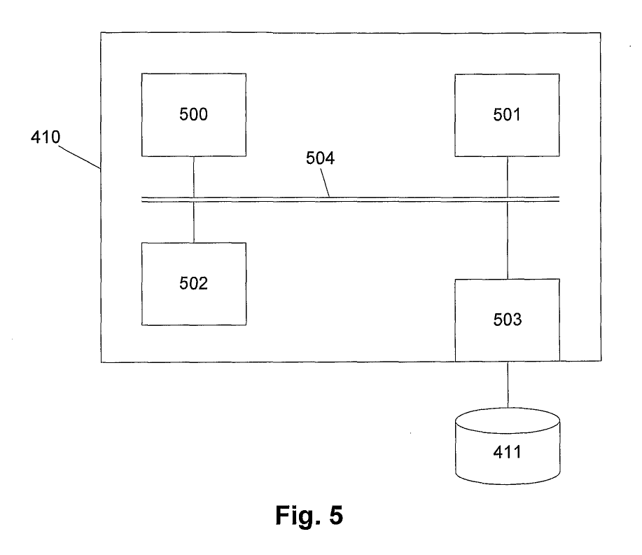

Accordingly, any form of suitable processing system 410 may be used. An example is shown in FIG. 5. In this example, the processing system 410 includes at least a processor 500, a memory 501, an input/output (I/O) device 502, such as a keyboard, and display, and an external interface 503, coupled together via a bus 504 as shown.

Accordingly, it will be appreciated that the processing system 410 may be formed from any suitable processing system, such as a suitably programmed PC, Internet terminal, lap-top, hand-held PC, or the like, which is typically operating applications software to enable data transfer and in some cases web-hosting and file transfer protocol (FTP) functionality. This would typically therefore require that the processing system 410 is a network server connected via a high-bandwidth connection to the Internet.

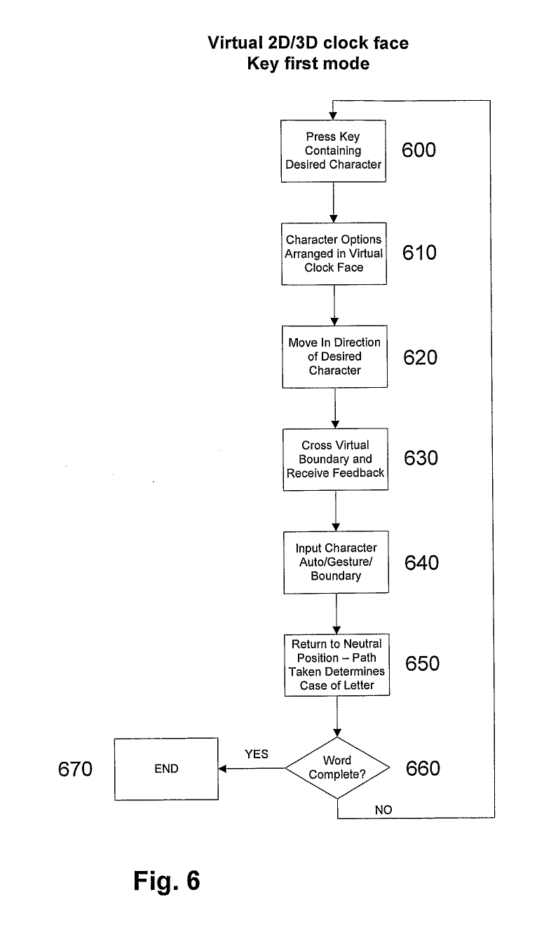

FIGS. 6 to 9 show further examples of the process that can be used in a device, such as the device 305 in FIG. 3 to cause various actions to be performed.

In particular, it will be appreciated that the movement of the device 305 can occur in two dimensional and/or three dimensional planes. In the following particular examples, the device 305 can be moved in directions in relation to a clock face/circular segmented arrangement, where various characters, words, or the like are angularly displaced (like a face of a clock) around a display means (such as a screen or the like) of the device 305. The characters/words can be entered into the device for entering general data/information, where for example, a user may set a reminder in a PDA, or write a text message in a mobile phone.

FIG. 6 shows an example process where at step 600 a key is pressed containing a desired character. It will be appreciated that typical keys on a mobile phone sometimes include numerous characters assigned to one particular key. Accordingly, at step 600 a key representing/associated with a particular character is pressed. At step 610 the various character options available/assigned to that particular key are displayed in a virtual clock face/circular segmented arrangement.

Thus, at step 620 a user can move the device in the direction of the desired character. Once the user crosses a boundary (which can be pre-determined and set on the device) at step 630, the user receives feedback (either positive or negative, but usually positive in that the character has been chosen/selected). Accordingly, at step 640, a character is inputted/selected either automatically (by moving the device across the boundary), via a particular gesture from the user, or across another boundary.

At step 650, the user can return the device to a neutral position, where the path taken to return the device to the neutral position can determine the case of the character. At step 660 it is determined if the word has been completed and if all characters have been chosen, then the process ends at step 670, otherwise the process continues back to step 600.

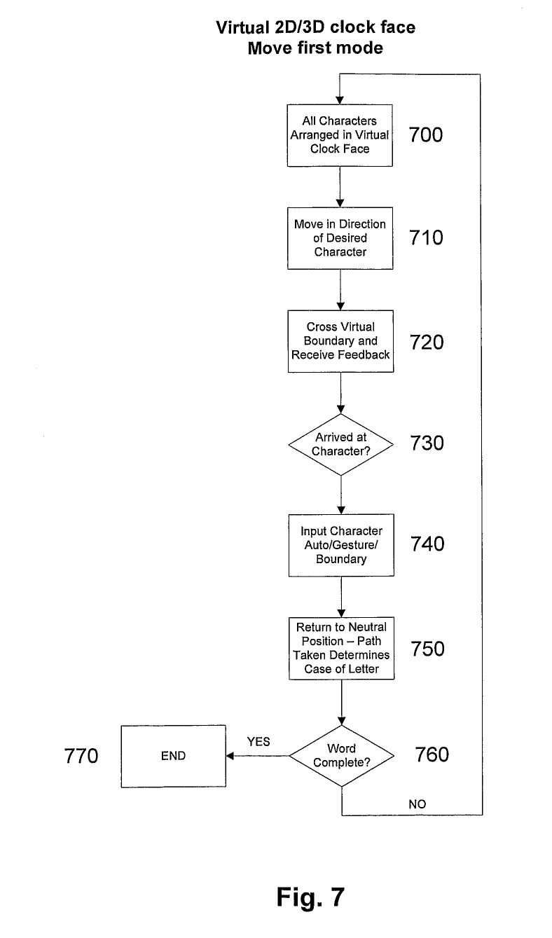

FIG. 7 shows an example process which may be applied if a character is inserted in respect of initial movement of the device (as opposed to pressing a key).

Accordingly, at step 700 all characters may be displayed in a virtual clock face/circular segmented arrangement where at step 710 the user moves the device in the direction of the desired character. At step 720 the user crosses a boundary and receives feedback in relation to the character entry. At step 730 it is determined whether the user has arrived at the desired character, and if this hasn't occurred then the process continues back to step 710, otherwise, the process continues to step 740 where the character can be inputted via a key press or gesture.

At step 750 the device can be returned to a neutral position, where the path taken can determine the case of the character. At step 760 it is determined whether the word is complete, and if the word is not complete, the process is continued back at step 700, otherwise, the process ends at step 770.

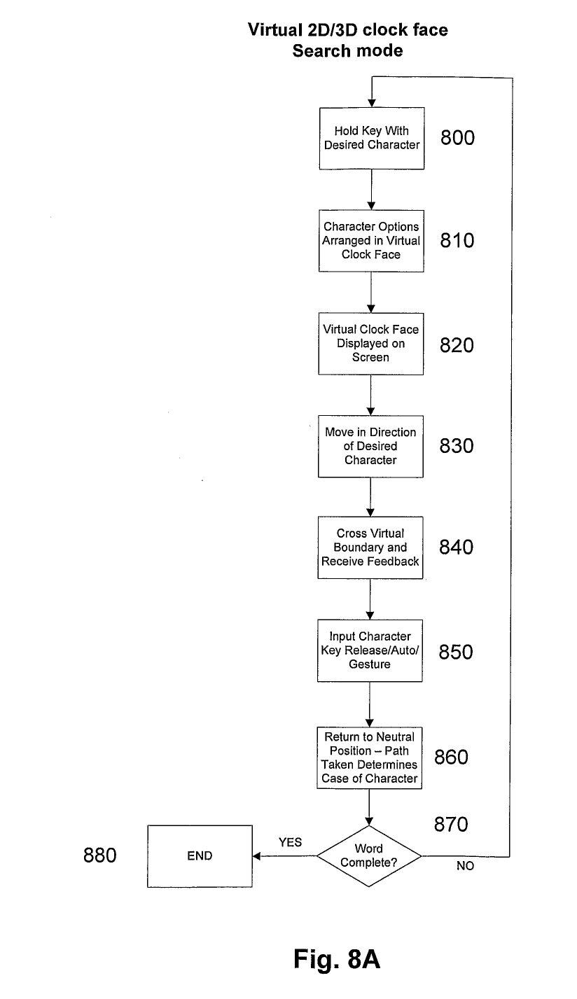

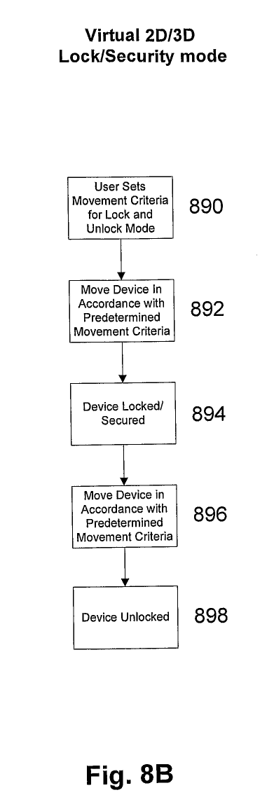

FIG. 8A shows an example of a device operating in search mode. In this particular example, the user holds the key with the desired character at step 800. At step 810 various character options are arranged in a virtual clock face/circular segmented arrangement, which can then be displayed in a screen of the device at step 820.

At step 830, the user can move in the direction of the desired character, where at step 840 the user can cross a boundary and receive feedback. At step 850, the character is inputted via key release, automatically, and/or via a gesture performed by the user, or, alternatively by crossing a boundary so if the user requires another character/word or data etc from the same key pressed, the user does not have to release the key and return to step 800. At step 860 the device can be returned to a neutral position, where the path taken can determine the case of the character. At step 870, it is determined whether the word is complete, and if not, the process continues back to step 800, otherwise, the process ends at step 870.

FIG. 8B shows an example process of the device being locked/secured and/or unlocked. In this particular example, at step 890 a user can set the movement criteria required for the device to be locked and/or unlocked. Notably, it will be appreciated that this may not be necessary, and that the movement criteria for the lock/unlock function may form a part of the device at the manufacturing process.

In any event, at step 892, the user may move the device in accordance with the particular movement criteria in order to lock the device at step 894. At step 896, the user may then move the device in accordance with movement criteria for unlocking the device 898. It will be appreciated that the movement for locking and/or unlocking the device can form a part of a direction that is angularly displaced from other directions where other action options can be selected. Alternatively, the movement can include movement of the device across various spatial boundaries and planes, and according to a further example, in a particular pattern, where the movement can be predetermined.

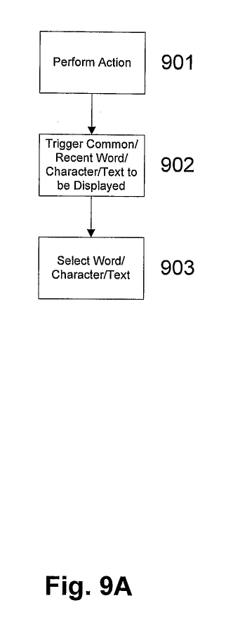

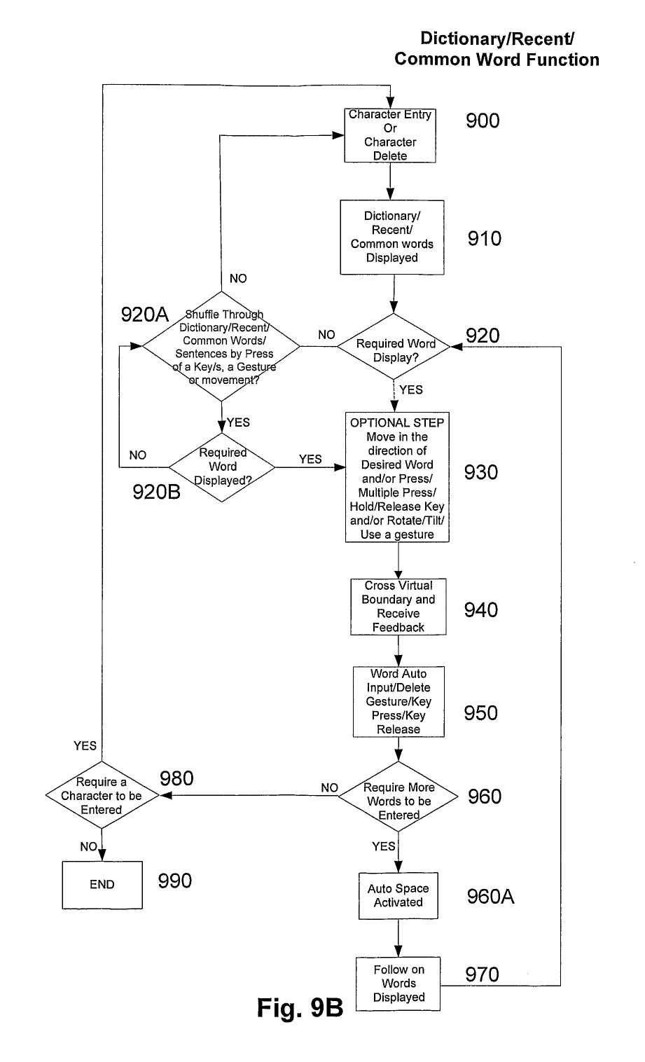

FIGS. 9A and 9B show an example process for using a dictionary word/recent word or a commonly used word function.

In particular, FIG. 9A shows a method of choosing and/or selecting text, where text can be a single character, a word, or a sentence by at step 901 performing an action, where the action triggers the display of the text at step 902, and choosing text from the selection displayed at step 903. In one particular example, the text selection displayed can be based on commonly used text/character, recently used text/character, and/or another user/manufacturer defined characteristic.

In a further example, FIG. 9B shows at step 900, that a user may enter a character, which may then trigger dictionary words, recent words used, common words or theme words to be displayed. Alternatively, a user may delete a character. Notably, in one particular example (although not necessary), the words may be displayed in a virtual clock face/circular segmented arrangement at step 910. At step 920, it is determined whether the required word is displayed. If this is not case, the user has the option to shuffle through dictionary words, recent words used, common words or theme words at step 920A (this can be done with the press of key/s, a gesture or movement, or to go back to step 900 to enter another character. If the user does want to shuffle at 920A then they continue to 920B and if the word is not displayed they may continue to shuffle at 920a or return to step 900 where another character can be entered.

Otherwise, the process continues to step 930 where the user can optionally move the device in the direction of the desired word displayed. It will be appreciated that for word selection to occur, the user can then select a key and in this particular example, it is not necessary for the user to move the device.

Notably, at step 930, a key can also be pressed or multi pressed (such as, for example, the press of the space bar, an enter key, or the like), for the device to recognise that a “word” displayed is to be entered rather than entering another “letter”. Accordingly, at step 930 the user can then move the device in the direction of the desired word displayed. Step 930 can also include recognising a gesture or movement performed by the user.

At step 940, the user may cross a boundary and receive feedback, where at step 950 the word is inputted either automatically, via a user gesture, and/or the press or release of a key.

At step 960 if the user requires more words, the process continues to 960a where a space is automatically activated and then to step 970 where words that follow on from previously entered words are displayed. The user can then return to step 920 and continue from required word displayed.

Furthermore from step 960, if the user doesn't require more words then the user may move onto step 980 giving the option for another character to be entered, which can take the user back to step 900 to start the process over again, otherwise the process has ended at step 990.

It will also be appreciated that the process of FIG. 9B can also be applied to recently used or common sentences, and is not limited to words, but can include any form of text that a user of the device may commonly use or has recently used.

### Further Examples

The description below provides further examples for character, word, sentences. and phrases (also referred to herein more generally a text selection). Furthermore, file selection and/or entry through movement in a circular segmented arrangements aided with dictionary, recent, recent-alphabetically, common word, theme words, phrase or words of speech access and search mode options with the option of mass and/or sound, light, voice feedback, and security lock on a device are also described below.

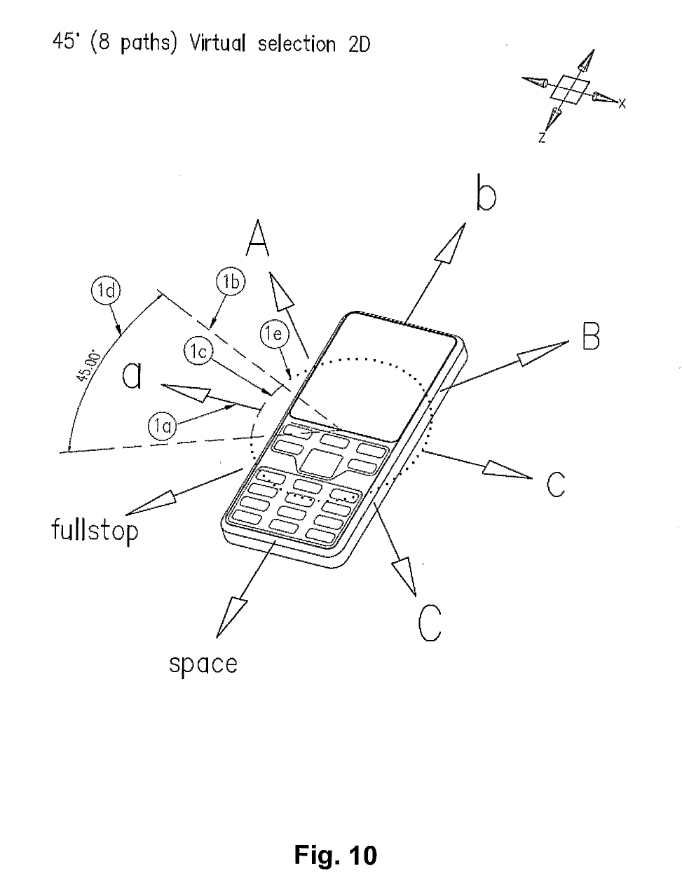

In one example, FIG. 10 illustrates a mobile phone (which is an example of the device referred to herein) that can be moved in different directions parallel to the keypad face for selection and/or entry of characters. Shown in 1a is a direction parallel to the keypad face. Example 1b illustrates the boundary of the character, and example 1c is the boundary to cross for acknowledgement of character selection.

In order to select a character, a user can move in a direction parallel to the keypad across 1c boundary and press the key that has the desired character; or to select in search mode, a user can hold down the key that has the desired character, the display unit may then display on the screen of the phone/apparatus the characters linked to the key pressed. The desired character can then be selected by moving in the direction of the virtual character parallel to the keypad across 1c boundary and then release of the key. In another example, for character entry, a user can press the key that has the desired character and move in the direction parallel to the keypad across 1c boundary and the character is entered.

Example 1e illustrates the user preferences boundary neutral zone—(zero, home etc).

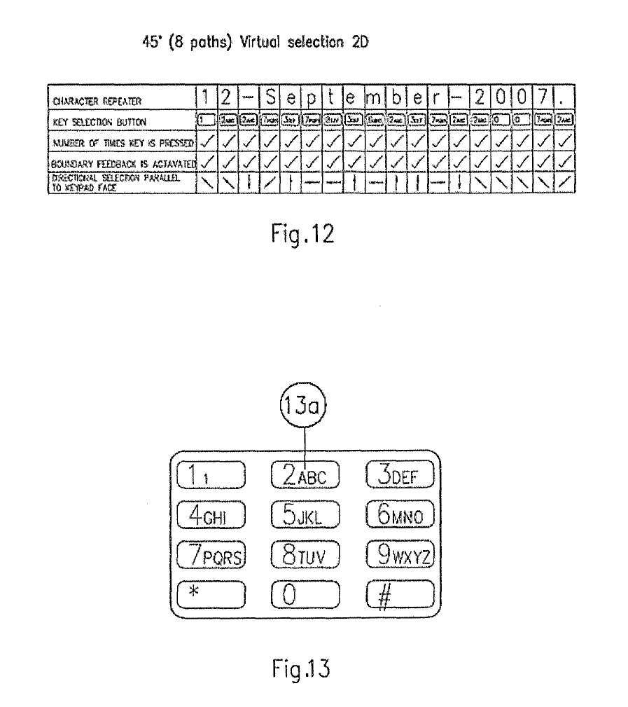

The set segmented angle for this example is 45° spaced evenly over the hour hands and concentrated around the center of the phone, in a circular segmented arrangement like on a clock face. The segmented character boundaries are not limited to 8 paths as in FIG. 10 and don't have to be evenly spaced to make 360°, they could be formed such that, 6 set at 50 and 2 at 10° and 2 at 20° to make 360, or set by manufacture and/or the user for ease of use. Example 1d illustrates the scope of the virtual selection area for character (a). FIG. 12 demonstrates the directional moves for this Virtual 2D Basic texting.

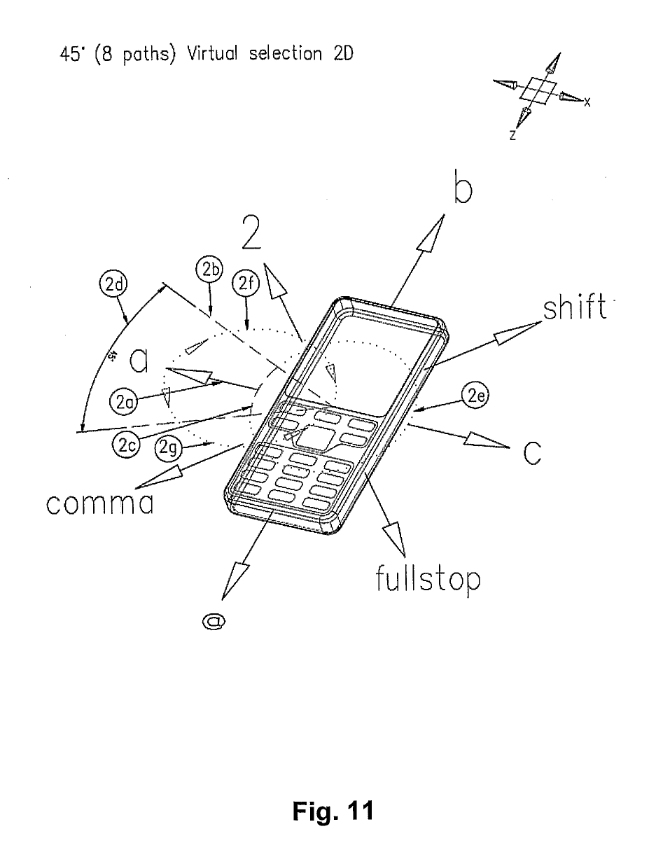

FIG. 11 illustrates an example of a mobile phone that can be moved in different directions parallel to the keypad face for selection and/or entry of characters. Shown in 2a is a direction parallel to the keypad face. Example 2b illustrates the boundary of the character, and example 2c is the boundary to cross for acknowledgement of character selection. In this example, in order to select a character, the phone is moved in a direction parallel to the keypad/screen, across boundary 2c and a key is pressed for the selection of the desired character.

Alternatively, in search mode, the key that has the desired character is typically held down, and the display unit then displays on the screen the characters linked to the key pressed. The desired character can then be selected by moving the device in the direction of the virtual character, parallel to the keypad or phone screen across boundary 2c, where the key can then be released.

FIG. 12 illustrates an example of Virtual 2D Basic texting, where an example sentence is entered, using an alphanumeric input keypad as indicated in FIG. 13, and directional movement for selection and enter as indicated in FIG. 10 with eight character/directional pathways.

FIG. 13 illustrates an alphanumeric data input keypad that can be used in an example device, such as a mobile telephone, or the like.

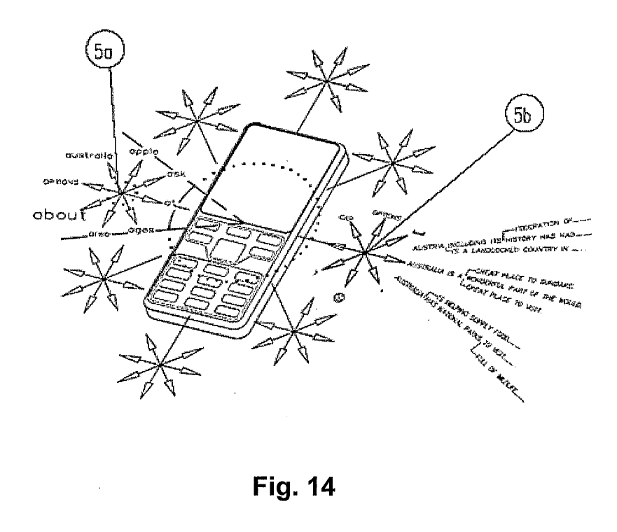

FIG. 14 illustrates a mobile phone that can be moved in different directions parallel to the keypad face to select words/characters/files etc. extended from the first characters as in FIG. 10 (Virtual 2D Basic texting). In particular, example 5a shows the directions for selection of words that start with (a) and an options path. FIG. 14 demonstrates some directional moves for Virtual Advanced 2D texting.

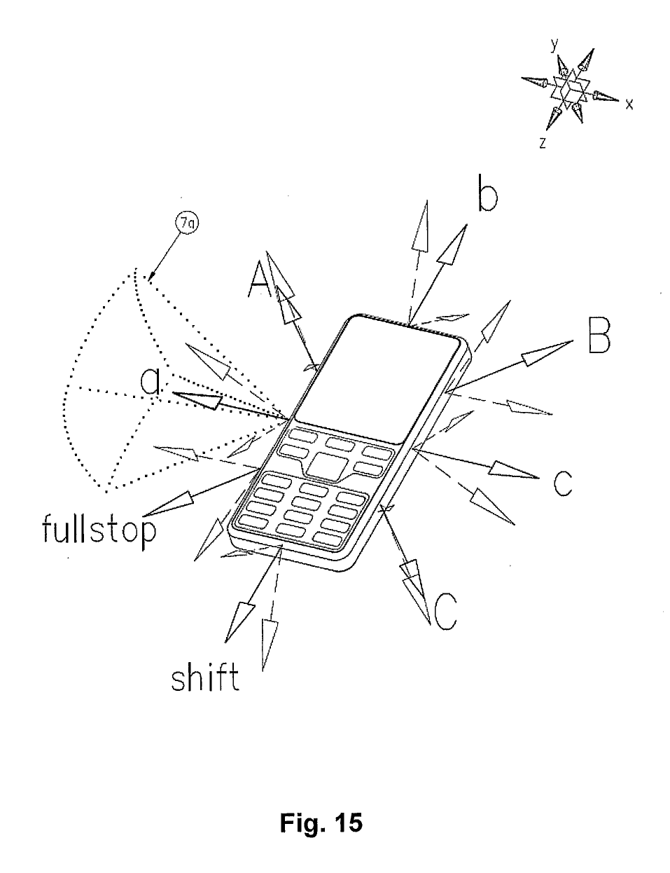

FIG. 15 illustrates a mobile phone that can be moved in different directions utilizing more than one plane (3D) to select characters in Virtual 3D texting. Indicated in 7a of FIG. 15 is the scope of virtual selection area.

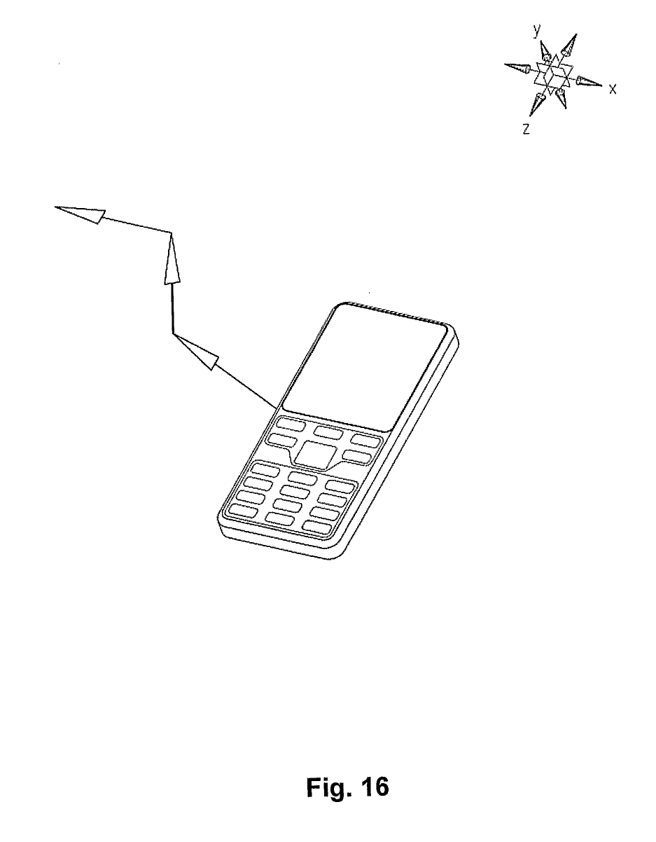

FIG. 16 illustrates a mobile phone that can be moved in different directions utilizing more than one plane (3D), as indicated in FIG. 16, to select characters in Virtual 3D texting. The difference between FIG. 15 and FIG. 16 is that FIG. 16 can use more than one direction of the phone/apparatus to select a character.

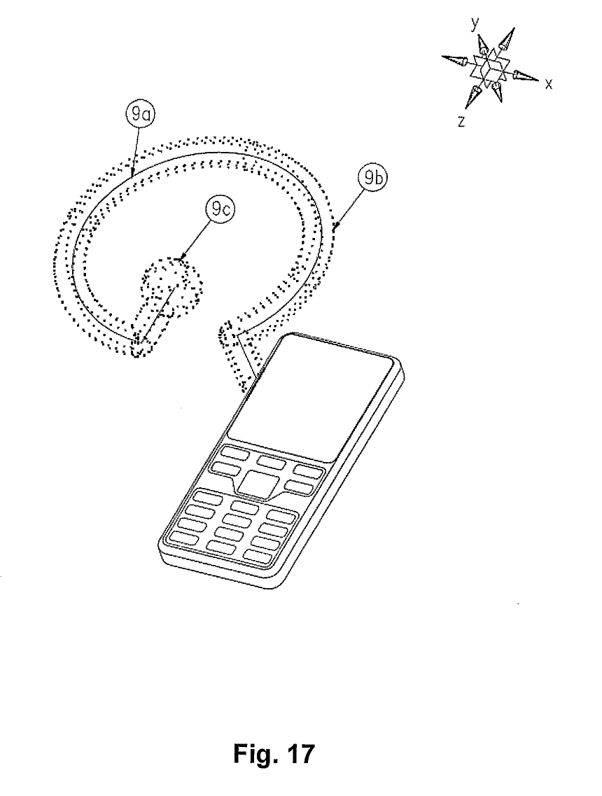

FIG. 17 illustrates the virtual path perimeters (tunnel extents) of a customary virtual security pathway for a mobile phone. Example 9a shows the pathway, 9b the tunnel boundary, and 9c the enter perimeter.

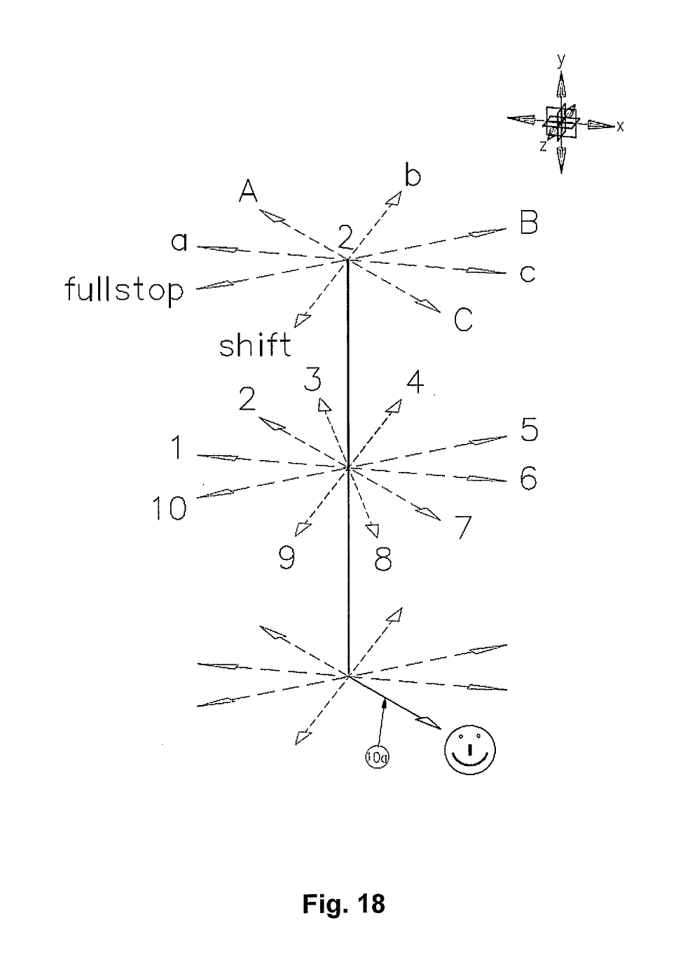

FIG. 18 illustrates an example of level access for 3D texting for selection of alphanumeric characters, non-English characters (e.g. Chinese), emoticons (as indicated in 10a of FIG. 18—the smiley face), and user preference words or files etc.

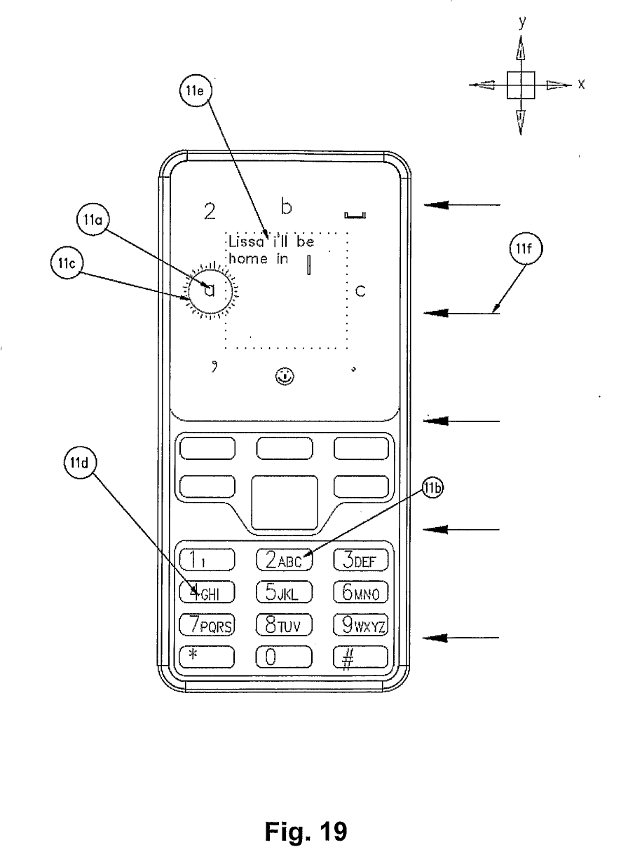

FIG. 19 illustrates a phone screen displaying an arrangement of characters. Example 11a shows the positioning of character around a clock-face. Shown in example 11b is the key that is activated for the character linked to that key to be displayed.

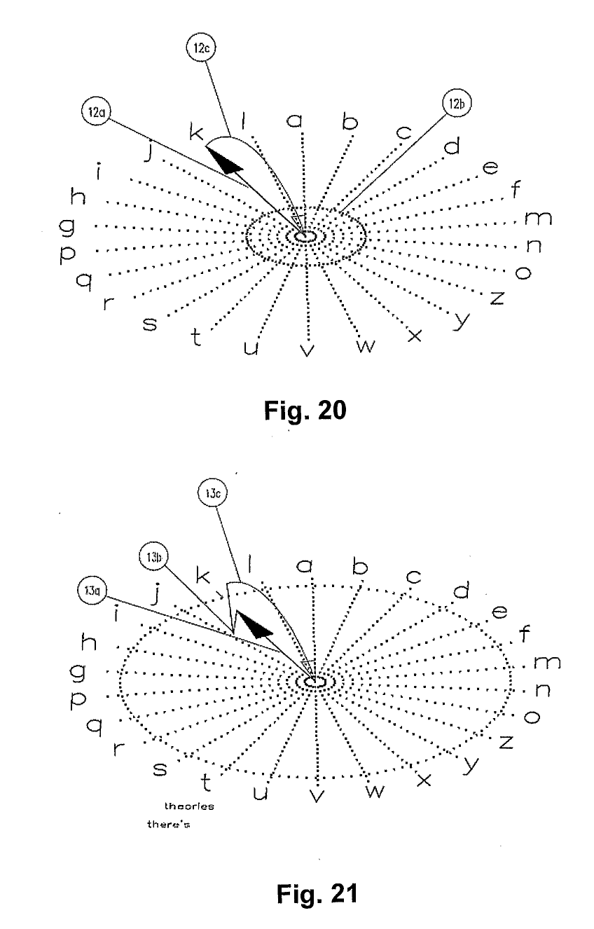

FIG. 20 illustrates the direction the phone moves towards a character and its return to re-zero. The example given in 12a shows how the phone/apparatus is moved towards a character and then past a set minimum virtual enter boundary 12b, which enters the character. The phone/apparatus is then moved to a preset zero mode—up and back to the start point as shown in example 12c makes the last character an upper-case letter, or down and back as shown in example 12d makes the last character a lower-case letter.

FIG. 21 illustrates the direction the phone moves towards a character and its return to re-zero. The example given in 13a shows how the phone/apparatus is moved towards a character. An example of virtual movement that coincides with enter is shown in 13b which enters the character. The phone/apparatus is then moved to a preset zero mode—up and back to the start point as shown in example 13c makes the last character an upper-case letter, or down and back as shown in example 13d makes the last character a lower-case letter.

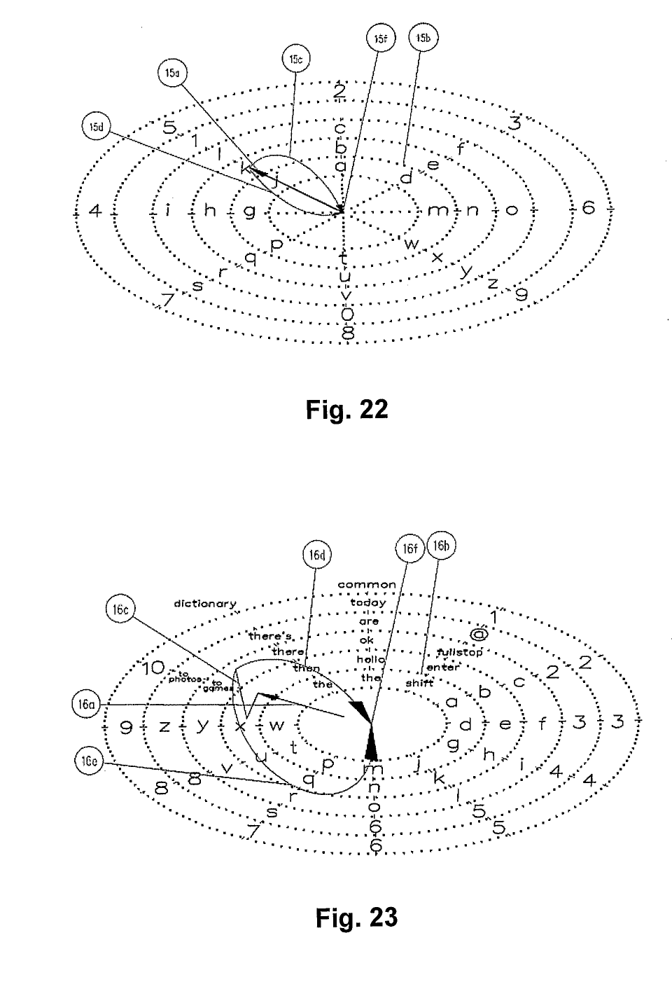

FIG. 22 illustrates the characters laid out on one plane in a circle formation with access to more characters within that same plane and circle formation. The example given in 15a shows how the phone/apparatus is moved towards a character for selection. Shown in example 15b is a boundary between characters that activates mass and/or sound/light/voice feedback to the user. Example 15c shows movement of the phone/apparatus to a preset zero mode—up and back to the start point makes the last character an upper-case letter, or down and back as shown in example 15d makes the last character a lower-case letter.

FIG. 23 illustrates the characters laid out on one plane in a circle formation with access to more characters within that same plane and circle formation. The example given in 16a shows how the phone/apparatus is moved towards a character. Shown in example 16b is a boundary between characters that activates mass and/or sound/light/voice feedback to the user. An example of virtual movement that coincides with enter is shown in 16c which enters the character. The phone/apparatus is then moved to a preset zero mode—up and back to the start point as shown in example 16d makes the last character an upper-case letter, or down and back as shown in example 16e makes the last character a lower-case letter.

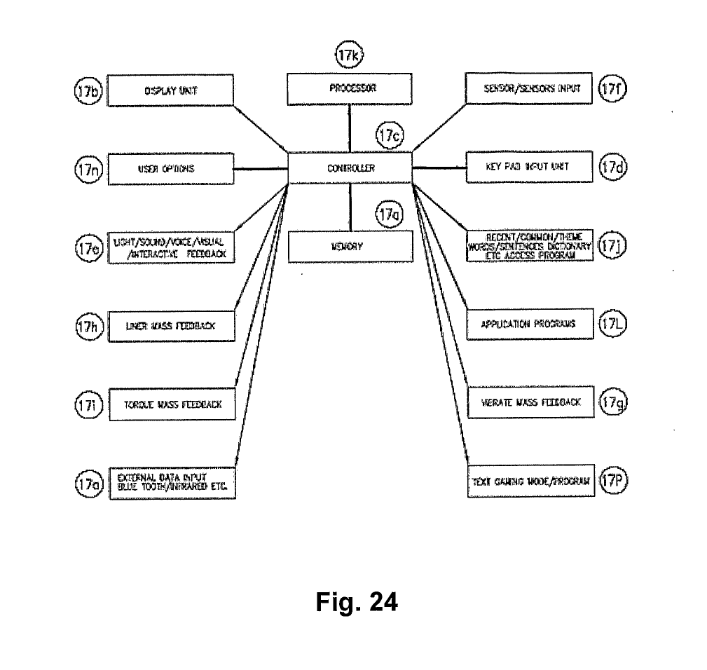

FIG. 24 is a block diagram illustrating an example of an internal configuration of the mobile phone according to an example. As shown in FIG. 24 the phone includes a memory 17a, a display unit 17b, a controller 17c, a key pad input unit 17d, sound/light/voice feedback 17e, sensor/sensors that can input 2D and/or 3D 17f, vibrate mass feedback 17g, linear feed back 17h, torque mass feedback 17i, recent/recent dictionary alphabetical/common/theme words/words of speech/phrases/sentences access program 17j, processor 17k, application programs 17L, user preferences 17n, an external data input blue tooth/infrared etc 17o, and 17p text gaming mode program.

Notably, as illustrated in FIG. 24, the sensor device (17f) inputs signals to a controller (17c) that matches the input signals (or estimates the closest approximate) to a database (17a) then to an application program (17L) (e.g. text program), or commands nominated to the keypad, or matrix of shelved files, or characters or another application program, or gestures that coincide with commands etc. For example, in the case of a mobile phone—the character ‘a’ on key [2abc], as in 13a of FIG. 13 or symbols, words, sentence, non-English language characters, photo-selection, files, paths, or security paths etc, can be assigned for entry when prompted.

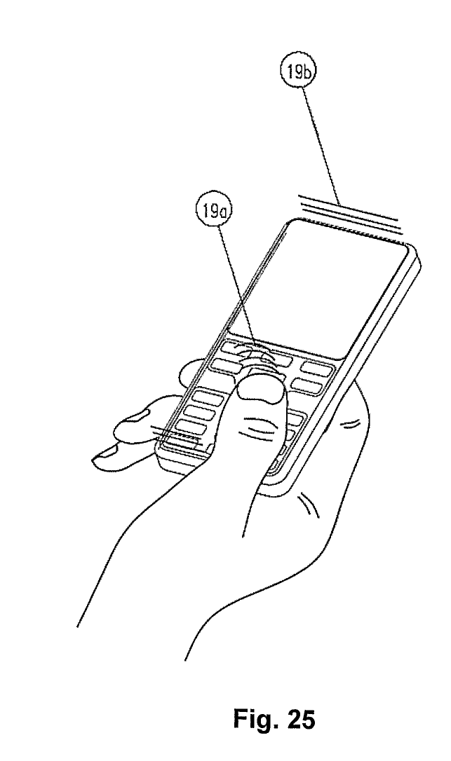

FIG. 25 illustrates an example of a the press of a key 19a with simultaneous movement of the phone 19b to select and enter text.

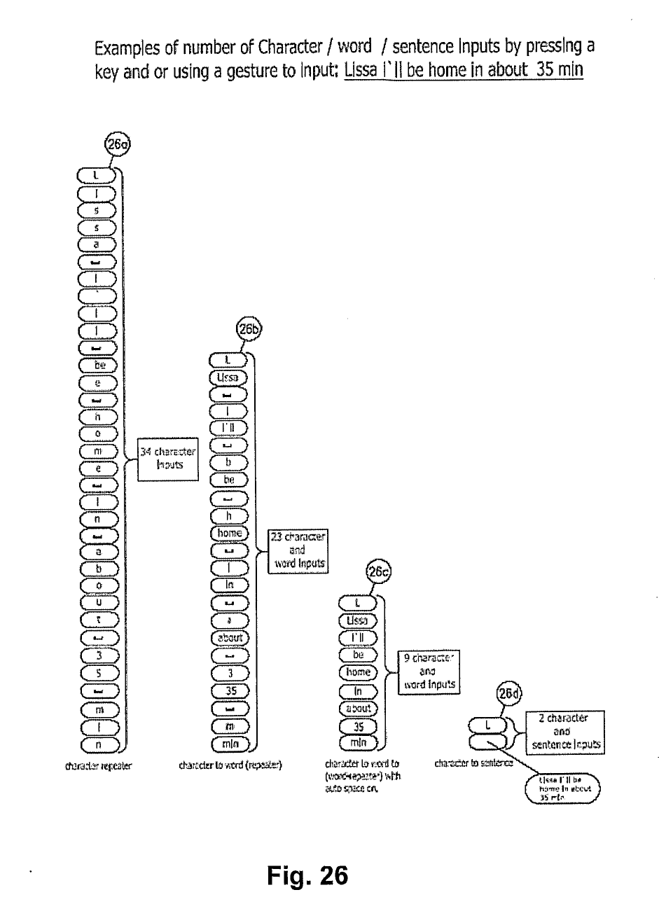

FIG. 26 illustrates the input of characters/words/sentences to write a text message in virtual 2D basic texting using the recent/recent alphabetical/common/theme words/words of speech/phrases access feature.

26a shows an example of the number of times a character (letter) is entered to write a message without using the recent/recent alphabetical/common/theme words/words of speech/phrases access features. 26b shows the number of times characters/words are entered to write a message when using a recent/recent alphabetical/common/theme words/words of speech/phrases access feature that starts each word with a character (letter). 26c shows how many times a key is pressed/word entered to write a message with recent/recent alphabetical/common/theme words/words of speech/phrases access feature.

Notably, once a word has been entered the words that are probable to be entered next are displayed on the screen of the phone/apparatus. These probable words are from recent/common/vocabulary or words of speech word groups. On character entry related words may be displayed for selection and then recent or commonly used words or theme words may continue to relate to other words used in conjunction; 26d shows the number of character/word/sentences/phrases entered when the first character relates to a recent sentence/phrase.

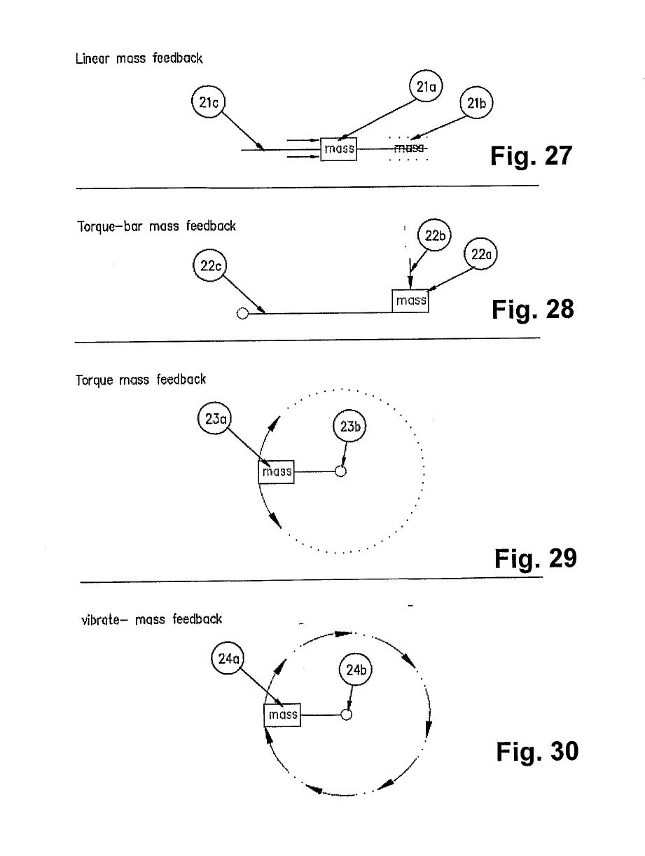

FIG. 27 illustrates linear feedback with accelerated or decelerated movement of mass 21a moving along/across a plane 21c, to example 21b.

FIG. 28 illustrates torque-bar feedback with mass 22a, that has been moved at a distance along a object 22c and is acted on by gravity 22b.

FIG. 29 illustrates torque-mass feedback with accelerated or decelerated movement of mass 23a, around a point 23b.

FIG. 30 illustrates vibration feedback with mass 24a, that is rotating around a point 24b.

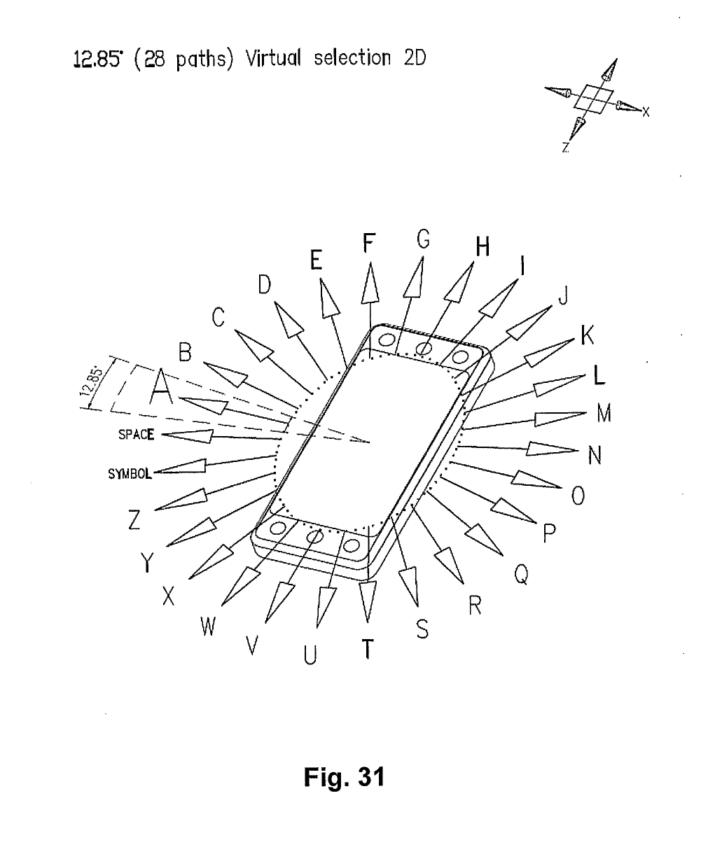

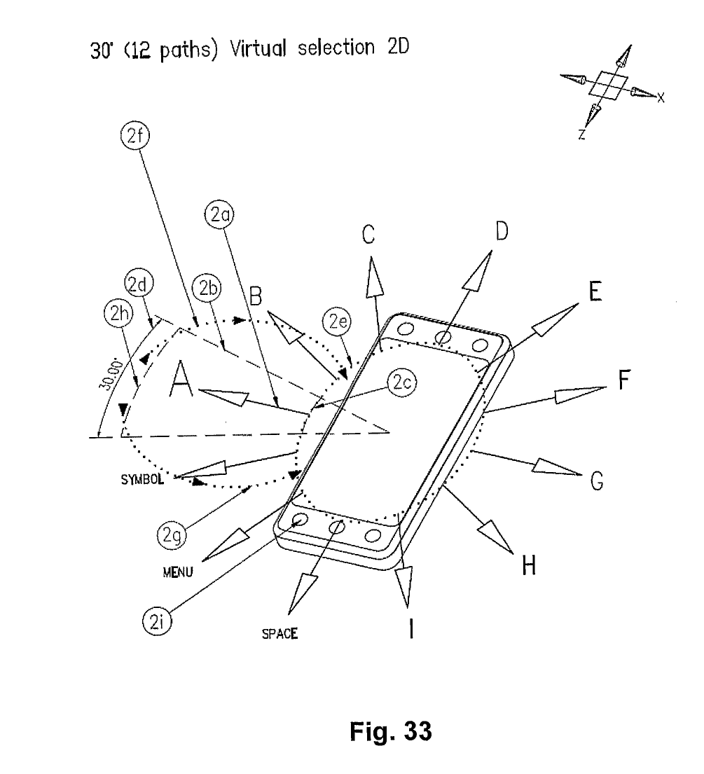

FIG. 31 illustrates an example of all of the characters in the alphabet plus other options, for example, symbol/space displayed around the screen at one time after the press of one key or a movement to display the same. Selection and entry of a character and search mode is performed in the same way as described and shown in accordance with FIG. 33. FIG. 31 illustrates a mobile phone that can be moved in different directions parallel to the keypad face for selection and/or entry of characters/words. This illustration gives an example of how the entire alphabet can be accessible on the screen. In this example, the device has a bigger screen display due to it not being necessary to have an alphanumeric/qwerty keypad.

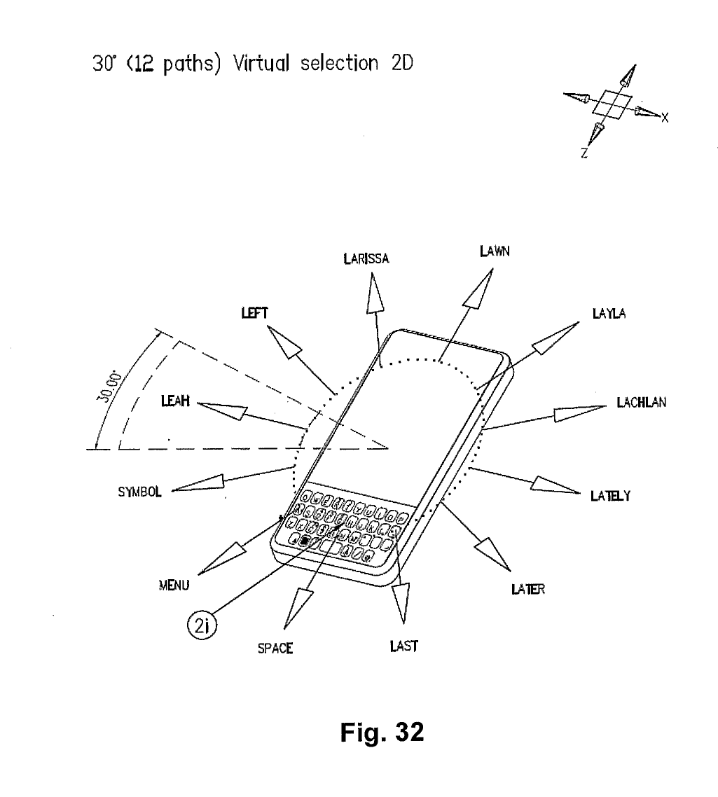

FIG. 32 illustrates a mobile phone that can be moved in different directions parallel to the keypad face for selection and/or entry of characters/words. By using the qwerty keypad, character, words, symbols and sentences can be displayed around the screen whilst typing. The words that are being typed prompt follow on words/sentences that can be selected and entered. Selection and entry of a character, word, sentence, phrase, or the like is performed as described in FIG. 33 below.

FIG. 33 illustrates a mobile phone that can be moved in different directions parallel to the keypad face for selection and/or entry of characters. Shown in 2a is a direction parallel to the keypad face. Example 2b illustrates the boundary of the character, and example 2c is the boundary to cross for acknowledgement of character selection. 2i is one of a set of keys that can be pressed to select a group of characters. 2h is the boundary to cross for entry of the character. In this example the device does not require an alphanumerical keypad. The alphabet is broken up into three groups which can include other symbols/commands, and different keys (eg: 2i) can be pressed to alternate between the groups. To select a character press the key which includes in its group the character required.

Additionally, alternating between the groups can be performed by multi press of just the one key. All characters/symbols/commands within that group may be displayed around the screen. The user then moves the device in a direction parallel to the screen, across 2c boundary for selection of the desired character and across another boundary 2h for automatic character entry. Alternatively, in search mode, whilst holding the key, the device can be moved in a direction beyond a boundary/tilted or rotated to navigate to another group.

Therefore, this can be done without having to press another key for group selection. Once arrived at the desired character, the character can be selected by moving the device in the direction of the virtual character parallel to the screen across 2c boundary and then releasing the key. Notably, whilst navigating through groups the set boundaries for character entry are overridden to enable navigation to other groups.

Key related groups can also include groups of words/sentences/phrases/theme words/words of speech, but are not limited to such.

Example 2e illustrates the user preferences boundary neutral zone—(zero, home etc).

The set segmented angle for this character is 30° spaced evenly over the hour hands and concentrated around the center of the phone, in a circular segmented arrangement like on a clock face. The segmented character boundaries are not limited to 12 paths as in FIG. 33 and all don't have to be evenly spaced to make 360°, they could be (e.g. 10 at 10° and 3 at 20° to make 360) to be set by manufacture and/or user for ease of use. Example 2d illustrates the scope of the virtual selection area for character (a).

As illustrated in FIG. 33 the clockwise movement 2f returning to the neutral zone (2e) may select lower case, and anti-clockwise 2g may select upper case.

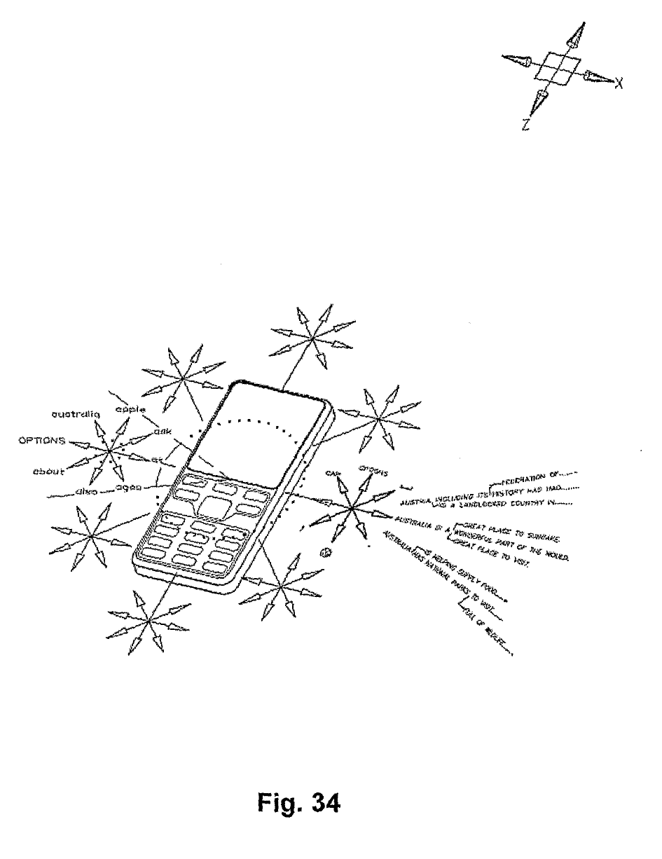

FIG. 34 illustrates a mobile phone that can be moved in different directions parallel to the keypad face to select word/characters/sentences/files etc. extended from the first characters as in FIG. 10 (Virtual 2D Basic texting). Example 5a shows the directions for selection of words with (a) and an options path. Example 5b shows sentences following on from words/characters that can be selected with directional movement/tilt/rotation etc.

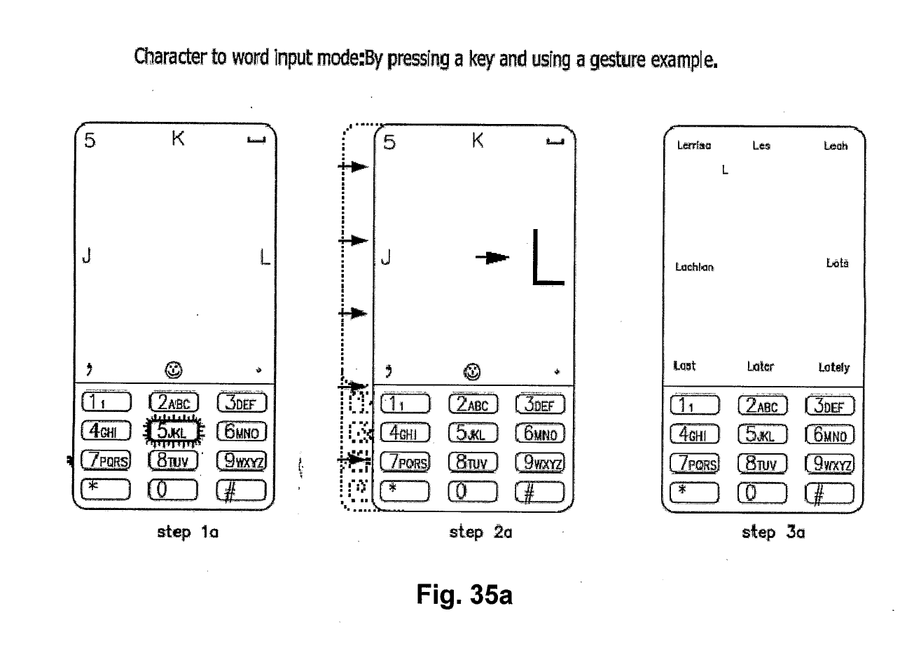

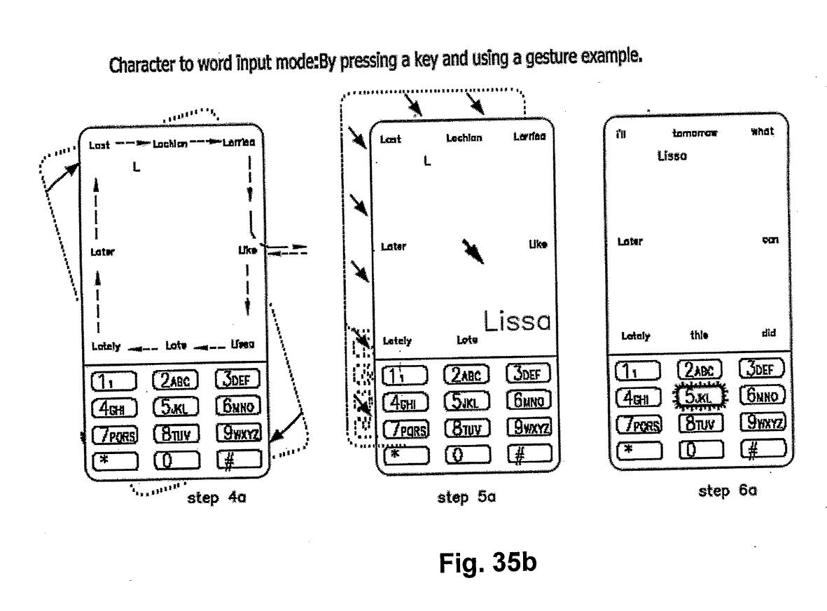

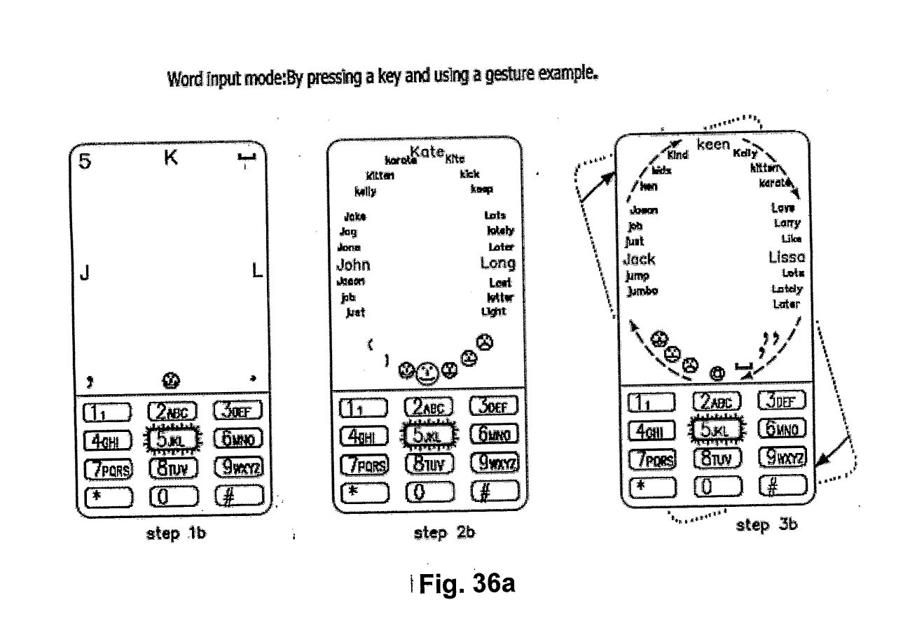

FIGS. 35a and 35b illustrate a character to word input on a mobile phone device by pressing a key and using a gesture. For example in step la the user presses the ‘5jkl’ key and some of the characters related to that key are displayed around the screen. In step 2a the phone is moved towards the character ‘L’ to select and enter the character. In step 3a words that start with at the start of a sentence are automatically displayed around the screen using dictionary/recent/common or theme word mode. The words that are displayed around the screen are optional so character input can continue through repeating step 1a. At any stage a key can be pressed with or without movement to enter a character rather than the words displayed. In step 4a the phone is rotated clockwise and introduces new dictionary/recent/common/theme words that start a sentence. If the phone is rotated anticlockwise another type or word access mode could be activated. In step 5a the phone is moved towards ‘Lissa’ to select and enter the word. In step 6 words that follow on from ‘Lissa’ near the start of a sentence are automatically displayed around the screen using dictionary/recent/common/theme word mode.

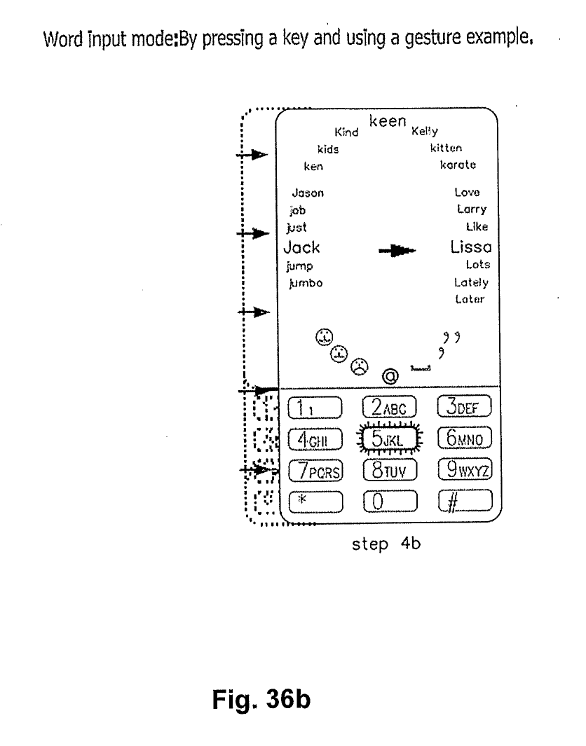

FIGS. 36a and 36b illustrate a word input mode on a mobile phone by pressing a key and using a gesture. For example in step 1b the user holds the ‘5jkl’ key and some of the characters related to that key are displayed around the screen. In step 2b while holding the ‘5jkl’ key a movement is performed that activates for example, recent word mode and words related to the characters connected to the key are displayed around the screen. In step 3b the phone is rotated clockwise to introduce new recent words for each character that starts a sentence. Alternatively, according to another example, the phone can be rotated anticlockwise to introduce new common words. If the word is there, the process continues to step 4b where the phone is moved towards the word ‘Lissa’ to select and enter the word. If the word is not displayed, step 1b is repeated where the last character that was inputted is remembered and the second character pressed may be added on to make words that relate to the combination of the characters that can be displayed, and the process continues to steps 2b, 3b, 4b. Once the word is entered in step 4b, likely new words that follow on from the last word are displayed. If the follow on word is not there, the key is released and step 1b is repeated.

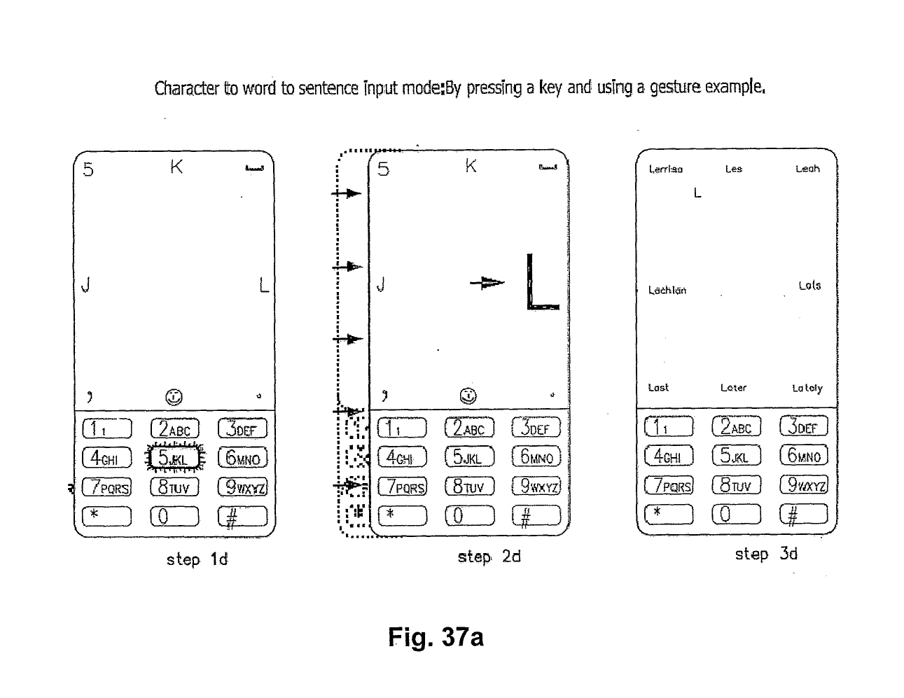

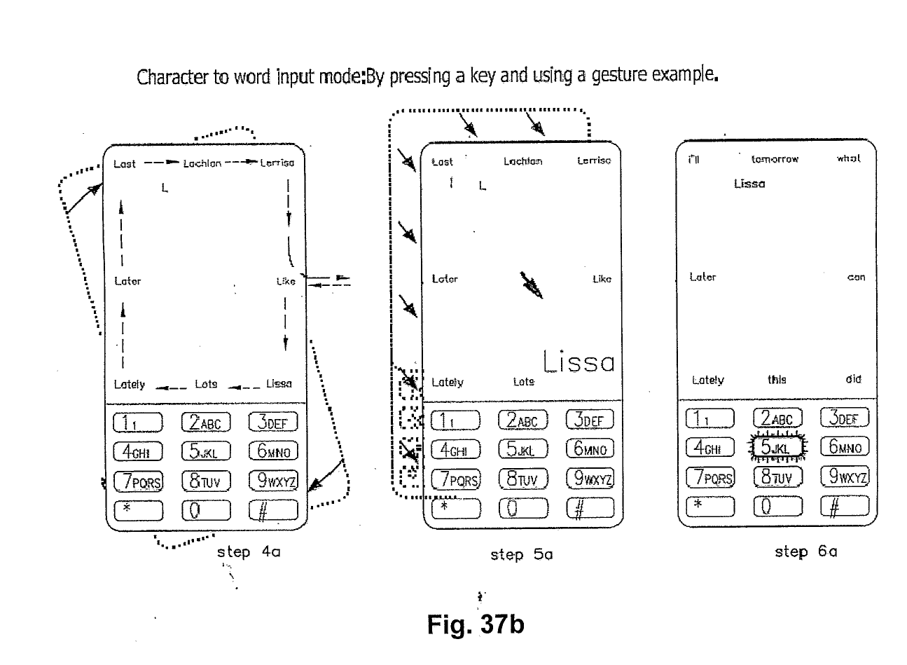

FIGS. 37a and 37b illustrate a character to word to sentence input mode on a mobile phone by pressing a key and using a gesture. For example in step 1d the user holds the ‘5jkl’ key and some of the characters related to that key are displayed around the screen. In step 2d the phone is moved towards ‘L’ to select and enter the character. In step 3d words that start with ‘L’ at the start of a sentence are automatically displayed around the screen using dictionary/recent/common/theme word mode.

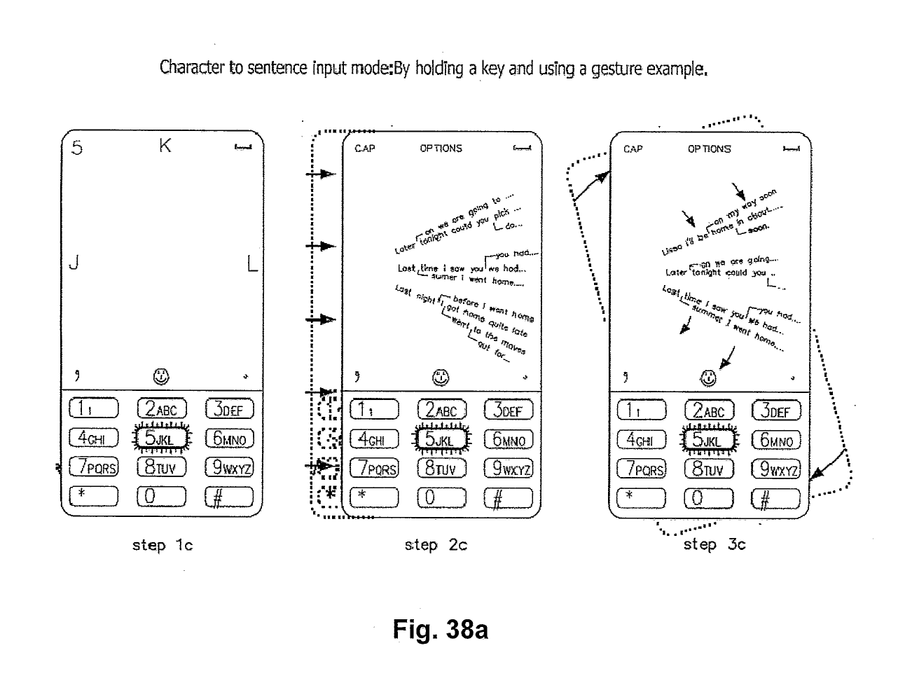

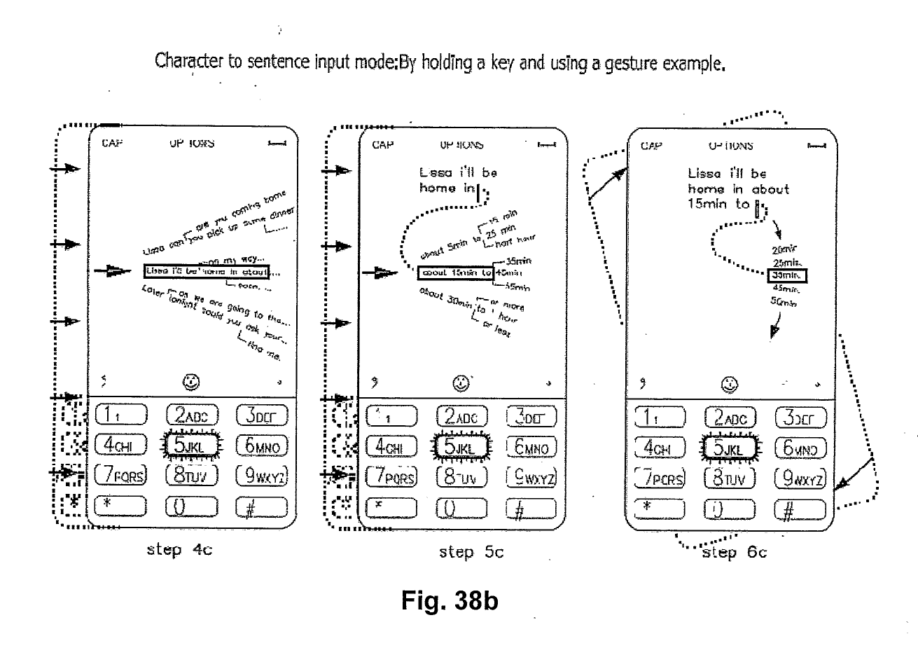

In this example recent word mode is used. In step 4d the phone is rotated clockwise to introduce new recent words that start a sentence. Alternatively, the phone can also be moved anticlockwise to introduce new common words. In step 5d the phone is moved towards the word ‘Lissa’ to select and enter the word. In step 6d the the ‘5jkl’ key is held, a gesture is performed and sentences that start /relate with the word ‘Lissa’ are displayed. Characters that may assist in sentence edit are displayed around the screen. To navigate through sentences the process continues on to step 3c in FIG. 38a.

FIGS. 38a and 38b illustrate a character to sentence input mode on a mobile phone device by holding a key and using a gesture. For example in step 1c the user presses the ‘5jkl’ key and some of the characters related to that key are displayed around the screen. In step 2c while holding the ‘5jkl’ key a movement is performed in the direction of the required character ‘L’ and the user performs a gesture with the device that activates sentence mode. Sentences that start/relate to the character are displayed. Characters that may assist in sentence edit etc are displayed around the screen. In step 3c the phone is rotated clockwise and the next sentence that starts with ‘L’ appears. In step 4c the phone is moved towards the sentence ‘Lissa I'll be home in about’ and a select box starts to select the character/word/sentence.

In this process the last word selected can be picked for entry or deleted by e.g. moving the phone up and/or down (a gesture). In step 5c as the sentence is selected in a forward direction it is automatically entered as it disappears off the end of the select box and appears in the text area. At the same time more of the sentence appears for selection in front of the select box. In step 6c at the junction rotate the phone and scroll through the list of words that follow on from the last selected character/word. The phone is moved in a forward direction to enter selected text as shown in step 5c or a gesture is used, for example, releasing the ‘5jkl’ key to enter part/all of the sentence.

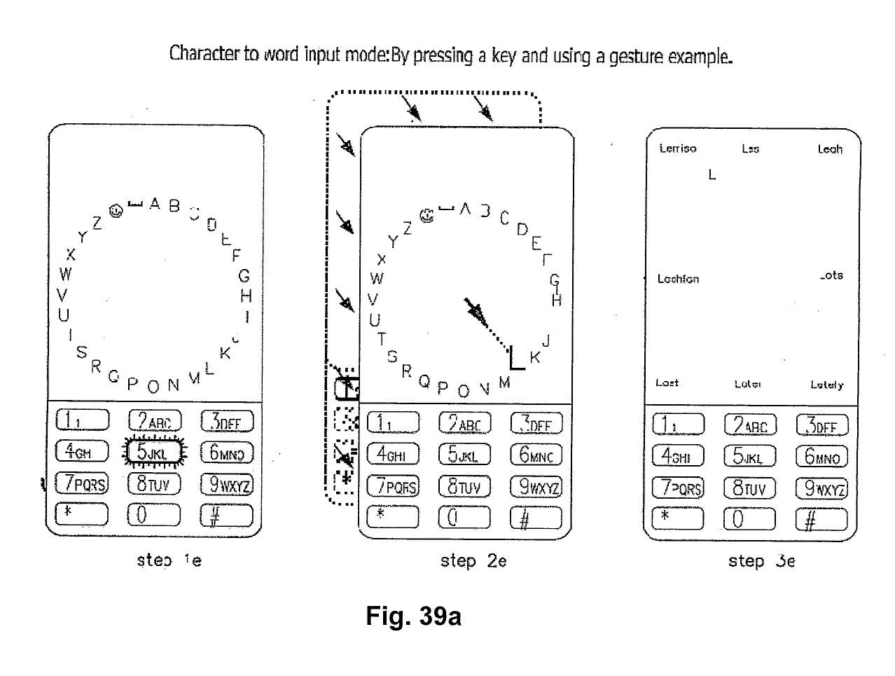

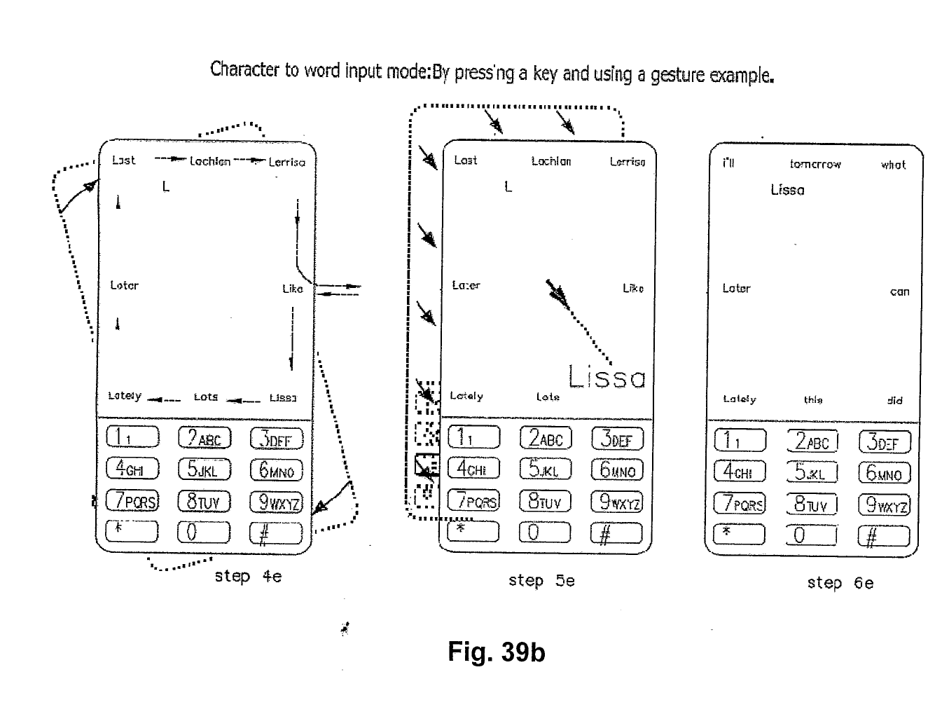

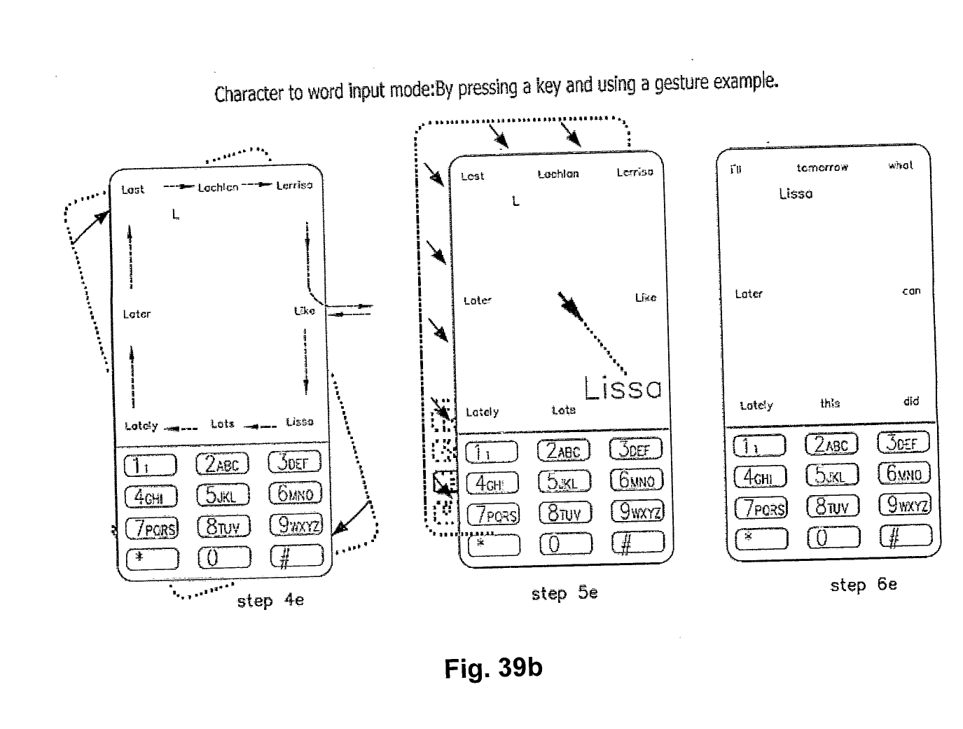

FIGS. 39a and 39b illustrate a character to word input mode by pressing a key and using a gesture. For example: In step 1e a user can hold a key and/or perform a movement that activates character/word mode and characters/words that relate to the key are displayed around the screen. In step 2e the phone is moved towards the character ‘L’ to select and enter the character. In step 3e words that start with ‘L’ at the start of a sentence are automatically displayed around the screen using dictionary/recent/common/theme word mode. At any stage a key can be pressed with or without movement to enter a character rather than the words displayed. In step 4e the phone is rotated clockwise and introduces new words, for example, recent words that start a sentence, or the phone is moved anticlockwise to introduce common words. In step 5e the phone is moved towards ‘Lissa’ to select and enter the word. In step 6e words that follow on from ‘Lissa’ near the start of a sentence are automatically displayed around the screen using dictionary/recent/common/theme words.

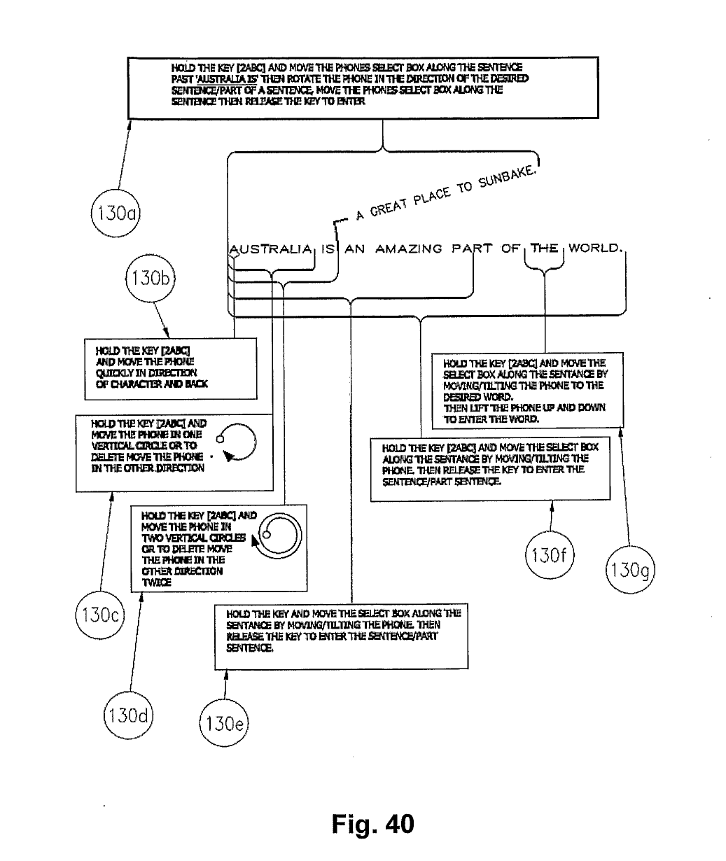

FIG. 40 illustrates an example of incremental word/sentence selection. To select a different part of a sentence following on from ‘Australia is’ as in example 130a, the user can hold the [2abc] key and move/tilt the phone's select box along the sentence past ‘Australia is’ then rotate the phone in the direction of the desired part of a sentence and then release the key to enter. To select the ‘A’ as in example 130b the user holds the key [2abc] and moves/tilts the phone quickly in the direction of the character and back. To select ‘Australia’ as in 130c, the user can hold the key [2abc] and move the phone in one vertical circle or to delete the last entered word move the phone in the other direction. To select ‘Australia is’ as in 130d, the user can hold the [2abc] key and move the phone in two vertical circles or to delete the last two entered words move the phone in the other direction twice. To select ‘Australia is an amazing pa’ as in 130e, the user can hold the [2abc] key and move the phone's select box along the sentence then release the key to enter part of the sentence on how far along the sentence the select box goes.

Alternatively, the user can hold [2abc] key and tilt the phone until the select box runs along the desired part of sentence and then release the key to enter. To select the full sentence ‘Australia is an amazing part of the world’ as in 130f, hold the [2abc] key and move the phone's select box along the sentence then release the key to enter the sentence. In another example, the user can hold [2abc] key and tilt the phone until the select box runs along the sentence and then release the key to enter. To select only a word in the sentence such as ‘the’ in example 130g, hold the key [2abc] and move the phone/tilt so the select box runs along the sentence until the word desired is reached then lift the phone up and down to enter the word.

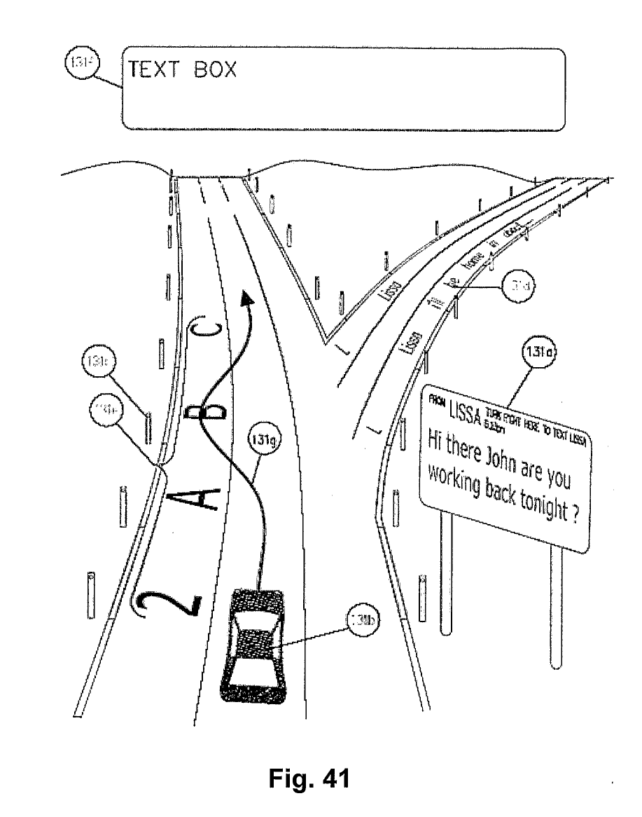

FIG. 41 illustrates an example of interactive game texting. The game is a car driving along a highway with multiple lanes, each lane can consist of character/word/sentence/part of a sentence/phrase that can be selected by the car (131b) driving down the highway over the desired character/word/sentence/part of a sentence/phrase or just pressing a key. Any word/s can be selected from a sentence by veering into the lane (131d) and driving over the word to enter. Follow on Characters/words/sentences that relate to previously entered characters/words/sentences to do with that person (Lissa) may now start to appear and can be similarly selected by driving over it. One word can be selected out of a sentence by driving over it.

According to yet a further example, to delete is that the user has to hit the reflector posts (131c) on the kerb line, which may then delete the last character/word input. The user may have to hit one post with the car to delete one character and as the car continues on and hits another post another character is deleted and so on. This could also apply to words. To the user's preference, this function could be adapted so that control of the car could be harder eg: due to speed. Every time the user hits a post they are losing text. This can make this feature more challenging requiring more skill. Also, as another challenge characters and words could move from lane to lane or race along the highway as the user tries to select them.

Also, a brake function could be available for eg: tilting the phone back

All the features for controlling the game are available through the moving of the device in a direction, or rotating/tilting the device, the press or multi press of a key or a gesture, or use of a touch screen/joystick/keypad steering wheel etc. Dictionary/recent/common/theme word modes can apply to this feature with words/sentences or a phrase being displayed in different lanes along the highway for the user to select from.

Signs along the road can notify the user of a new message with the message written on the sign but not limited to only a sign. To respond to the message the user follows the direction of the sign eg: ‘turn right here to text Lissa’ as in FIG. 41 example 131a. The highway that is turned on to can have character/words/sentences in different lanes that relate to the person that the user is responding to based on previous text messages to that person.

A message can be sent by using a particular highway lane/turn off etc or running over a command. Two or more people could be participating in a text messaging game. Group texts/emails can also be sent and received and the address book can be accessed through a similar process of going down or turning off a particular highway/lane.

This system can also be played on a desktop computer controlled by remote connection to a device, such as a mobile phone, or the like.

The idea of the interactive text gaming is not limited to this example format. There can be a multitude of ways of accessing, selecting and entering characters/words/sentences/part of sentences or phrases with directional movement/tilting/rotating of a device or touch of a screen/joystick/keyboard or mouse. The functions that have been described herein are made available in the game eg: the [2abc] key can be pressed and the characters can be displayed in a lane as in this example 131e, the left lane. 131g is an example of the path the car would take to select the letter ‘B’

131f is the area that the text is input (text box). The text box can also display information about gaming eg: users/components score.

The above-described method and device can provide operations and methods for easier text/word/phrase/sentence selection and entry, file access, virtual security lock and search mode, with guidance along and over (through) virtual paths with character/file selection and/or enter acknowledgement by mass and/or sound/light/voice and/or dictionary and/or visual feedback to the user of the device. On any handheld electronic/digital device this is performed by the press of a key and one virtual movement, a number of virtual movements, one virtual movement or a number of virtual movements and the press of a key, one virtual movement or a number of virtual movements for selection, and/or entry of characters. The functions mentioned above are performed with the use of a virtual circular segmented arrangement as shown in FIGS. 10 31, 32, 33, 18, 20, 21, 22, and 23 with a home position zone 1e commonly at the center of the circular segment or (sphere segment in 3D mode).

The selection of characters/words/phrases/sentences and/or files, and the creation of virtual pathways, all occur through pressing of a key and/or movement of the device using at least one sensor that senses the accelerated movement of the device in any orientation or direction, in respect to the home position. In one particular example, an accelerometer is used. However, various sensors or devices that sense accelerated and/or movement can be used for e.g an accelerometer, a gyroscope/gyrosensor, an inclinometer, a distance, surrounding, infrared, camera, GPS, Bluetooth, location or angular speed sensor.

According to another example, the device can have preset or customary movements for selection or entry of upper or lower case characters, or activation of a function, which does not require a key to be pressed.

Accordingly, the above-described device can facilitate speed and ease of selection for texting on a mobile phone or any other handheld electronic/digital device with a texting wording or character enter function.

The following further describes the features of the present application.

1. Clock-Face: circular segmented arrangement for selection and/or entry of characters/words/sentences/phrase (e.g. Virtual 2D basic and advanced texting as in FIGS. 10, 31, 32, 33 34, 18 to 23) with the option of selection and entry recognition through sound/light/voice/visual and/or dictionary and/or mass feedback. A feedback device or a combination of feedback devices can provide guidance along, through or over boundaries.

2. Methods of character selection and entry using an application program (e.g. text program) with the option of using all types of feedback.

(a) Key Selection With Virtual Character Entry Using Virtual 2D Texting: Press the key with the desired character and move beyond the set minimum enter boundary in the desired direction of the virtual character until mass and/or sound and/or dictionary feedback is activated acknowledging that entry has occurred. (FIGS. 10, 15, 18, 20 21,32, 33, 34).

(b) Virtual Character Selection With Key Entry Using Virtual 2D Texting: Find the key with the desired character and move beyond the set minimum selection boundary in the desired direction of the virtual character, until mass and/or sound and/or dictionary feedback is activated, acknowledging that the key in relation to the desired character can now be pressed to enter the character. (FIGS. 10, 15, 18, 20 to 23, 32, 33, 34).

(c) Key Selection With Virtual Character Entry Using Virtual 3D Texting: Press the key with the desired character and move beyond the set minimum enter boundary in the desired 3D direction of the virtual character until mass and/or sound and/or dictionary feedback is activated, acknowledging that entry has occurred. (FIGS. 15 and 16).

(d) Key entry simultaneously with virtual character selection: The use of different gestures whilst pressing of a key, as shown in 19a as in FIG. 25. For example a slightly harder press of key or quicker tilting, or slight rotation of the phone/apparatus etc, so the movement of the phone as shown in 19b is noticeably different to the sensor/sensors than a lighter or slower press etc so different characters linked to the same key can be entered. For example To enter ‘a’ lightly press [2abc] key once and “a” is entered, to enter ‘b’ press slightly harder on the same key [2abc] once and ‘b’ is entered. This system can be used with directional movement as well to select other types of the movement characters linked to the key e.g. upper case characters.

(e) Virtual Character Selection With Key Entry Using Virtual 3D Texting: Find the key with the desired character and move beyond the set minimum selection boundary in the desired 3D direction of the virtual character, until mass and/or sound and/or dictionary feedback is activated in acknowledgment that the key in relation to the desired character can now be pressed to enter the character. (FIGS. 15 and 16).

(f) Character selection through movement of the phone/apparatus in a particular direction beyond a set virtual selection boundary with mass and/or sound and/or dictionary feedback as acknowledgment to the user that the virtual selection boundary has been crossed, as shown in 16b of FIG. 23. No use of keys required. (FIGS. 10,15, 16, 18, 20, 21,22, 23, 31, 32, 33, 34).

(g) Character enter through movement of the phone/apparatus in a particular direction beyond a set virtual enter boundary with mass and/or sound and/or dictionary feedback acknowledging that the enter boundary has been crossed and entry of the character has occurred, as shown in example 12b of FIG. 20. (FIGS. 10, 15, 16, 18, 20, 21,22, 23, 31, 32, 33, 34).

(h) Character selection through the press/multipress of a key to select a group of characters and movement in a particular direction beyond a set virtual selection boundary with mass and/or sound and/or dictionary feedback as acknowledgment to the user that the virtual selection boundary has been crossed (FIGS. 31, 32, 33).

(h) Upper case option after using virtual movements for character selection and entry by using a movement that coincides with enter upper case. Move phone/apparatus in a particular direction beyond a set virtual selection boundary with mass and/or sound and/or dictionary feedback may alert the user that a selection boundary has been crossed and character selection has occurred, as shown in 16b in FIG. 23, then the virtual movement that coincides with enter upper case can be performed (16c), and upper case is activated by returning to zero position as shown in 16d. No use of keys required. (FIGS. 10, 20-23, 33).

(i) Lower case option after using virtual movements for character selection and entry by using a movement that coincides with enter lower case. Move in a particular direction beyond a set virtual selection boundary with mass and/or sound and/or dictionary feedback may alert the user that a selection boundary has been crossed and character selection has occurred, as shown in 16b in FIG. 23, then the virtual movement that coincides with enter can be performed (16c) and lower case is activated by returning to zero position as shown in 16e in FIG. 23. No use of keys required. (FIGS. 10, 20-23, 33).

(j) Upper Case Character Entry Option Following Pressing of a Key and Virtual Character Selection: Press the key with the desired character and move beyond the set minimum enter boundary in the desired direction of the virtual character until mass and/or sound and/or dictionary feedback is activated acknowledging that entry has occurred, as shown in 2c in FIG. 11. The selected character can then be entered in uppercase by returning as shown in (2g), to the zero position (2e). (FIGS. 10, 20-23, 33).

(k) Lower Case Character Entry Option Following Pressing of a Key and Virtual Character Selection: Press the key with the desired character and move beyond the set minimum enter boundary in the desired direction of the virtual character until mass and/or sound and/or dictionary feedback is activated acknowledging that entry has occurred, as shown in 2c in FIG. 11 The selected character can then be entered in lowercase by returning as shown in (2f), to the zero position (2e). (FIGS. 10, 20-23, 33).

(I) Upper Case Character Entry Option Following Character Selection: by virtual movement to a set selection boundary with mass and/or sound and/or dictionary feedback to alert the user that a selection boundary has been crossed and character selection has occurred, as shown in 15b in FIG. 22. The selected character can then be entered in uppercase by returning, as shown in (15c), to the zero position (15f). No use of keys required. (FIGS. 10, 20-23, 33).

(m) Lower Case Character Entry Option Following Character Selection: by virtual movement to a set selection boundary with mass and/or sound and/or dictionary feedback to alert the user that a selection boundary has been crossed and character selection has occurred, as shown in 15b in FIG. 22. The selected character can then be entered in lowercase by returning as shown in (15d), to the zero position (15f). No use of keys required. (FIGS. 10, 20-23, 33).

(n) High G-Force Character Selection and/or Entry: by suddenly moving the phone/apparatus in a particular direction characters can be selected and/or entered with mass and/or sound and/or dictionary feedback to alert the user of selection and entry boundaries. (FIGS. 10, 15, 18, 20, 21, 31, 32, 33, 34, 35a and 35b, 36a/b, 37a/b, 38a/b, 39a/b, 41).

(o) High speed rotation (tilt) selection and/or enter by moving the phone/apparatus in a particular direction and rotating (tilting) characters can be selected and/or entered with mass and/or sound and/or dictionary feedback to alert the user of selection and entry boundaries. (FIGS. 10, 15, 18, 20, 21, 31, 32, 33, 34, 35a/b, 36a/b, 37a/b, 38a/b, 39a/b, 41).

(p) High speed selection and/or enter through movement in a particular direction to and/or towards the virtual character (FIGS. 10, 15, 18, 20, 21, 31, 32, 33, 34, 35a/b, 36a/b, 37a/b, 38a/b, 39a/b, 41).

3. Calculating virtual movements with dictionary text mode. A way not to confuse the phone/apparatus on the users actions is to have a dictionary text mode calculating with the movements of the phone/apparatus the probable desired character or a character at all to be selected and or entered.

4. Dictionary word mode suggests the probable desired words etc to be entered, and can be either selected by the user as an option or automatically activated in recent/recent alphabetical/common/theme word or words of speech access mode after selection of the 2^{nd} or onward character, dependent on user preference. Word/s from dictionary words used in relation to a previously entered character/word/sentence or part there of can be selected/entered.

5. Recent word access mode enables access to the most recently used words entered, they are an extension of the character selected, i.e. the first or 2^{nd} letter (character etc) of the word. This function can reduce greatly the number of selections required when text messaging etc, by offering the user the option of selecting words or whole or part of sentences recently used rather than characters. Word/s from recently used words in relation to a previously entered character/word/sentence or part there of can be selected/entered.

6. Recent alphabetical word access mode may list recently used words in alphabetical order for selection. When recent alphabetical word access mode is being used, alphabetical order of the 2^{nd} letter takes preference over most recently used words. Word/s from recently alphabetically used words in relation to a previously entered character/word/sentence or part part there of can be selected/entered. The recent alphabetical word access function is a user preference that can greatly reduce the number of selections required when text messaging etc, by offering the user the option of selecting words or whole or part of sentences commonly used rather than characters.

7. Common word access mode offers the same access to words and sentences as the recent word access function. It enables the user of the phone/apparatus access to the most commonly used words entered, they are an extension of the character selected, i.e. the first or 2^{nd} letter (character etc) of the word. Word/s from commonly used words in relation to a previously entered character/word/sentence or part there of can be selected/entered. The common word access function is a user preference that can greatly reduce the number of selections required when text messaging etc, by offering the user the option of selecting words or whole or part of sentences commonly used rather than characters.

8. Vocabulary mode which offers access to theme words that relate to a person eg: scientist, nurse etc, or different categories of subject matter eg: colour, feelings, scientific, medical, formulas etc. Word/s from a theme in relation to a previously entered character/word/sentence can be selected/entered.

9. Words of speech mode which offers access eg: nouns, verbs, adjectives, prefixes, suffixes, pronouns, conjunctions etc. Word/s from words of speech in relation to a previously entered character/word/sentence can be selected/entered.

8. Recent/common sentence access mode enables the user to select and enter a complete sentence when using virtual 2D basic and advanced texting. Sentences/phrases can be selected through previously entered sentence/phrase or part there of.

9. Search Mode by Holding Down a Key: the user can navigate by moving the phone/apparatus in a particular direction to find a character linked to that key, or level, displayed on the screen with the aid of optional mass and/or sound/light feedback mode to alert the user of the boundaries. By releasing the key or a gesture (i.e. virtual movement) by the user that coincides with enter, the character is entered. This is especially useful for selecting characters and files in a web as the virtual position is held on the web whilst the key is held down.

10. Search Mode by Pressing a Key: the user can navigate by moving the phone/apparatus in a particular direction to find a character linked to that key, or level, displayed on the screen with the aid of optional mass and/or sound/light feedback mode for the boundaries. Enter of character is achieved by a gesture (i.e. virtual movement) by the user that coincides with enter.

11. Security Mode: user can create their own virtual paths for security lock and/or unlock and with the aid of mass and/or sound/light feedback they can learn their virtual security paths before setting the security lock in the phone/apparatus.

12. Gaming Mode: The idea of the interactive aspect of this invention can be used for gaming eg: text messaging can be turned into a game as illustrated in FIG. 41.

13. Interactive Mode: Interactive selection/entry of characters/words etc can be performed using directional movement/tilt/rotation or a touch screen. Also manipulation of the arrangement of characters on the screen can be performed.

14. Delete Function: delete can be performed similar to selection to selection/entry through the movement of the device; be that directional, rotational, tilting or shake etc, or just by pressing a key.

12. Torque Mass Feedback: for guidance along, through or over boundary's and/or character/word etc selection and/or input through movement of the phone/apparatus in a particular direction (excluding locking and unlocking Security mode). Torque feedback is accelerated or decelerated movement of mass, example 23a, around a point 23b in FIG. 31. The mass that is moved/turned or tilted etc to create mass feedback could be an existing part of the phone/apparatus e.g. the battery.

13. Linear Mass Feedback: for guidance along, through or over boundary's and/or character/word etc selection and/or input through movement of the phone/apparatus in a particular direction (excluding locking and unlocking Security mode). Liner mass feedback is accelerated or decelerated movement of mass along/across a plane, example 21c in FIG. 27. This is used for simulating collisions into the boundaries by the apparatus in virtual space as in FIG. 27. The mass that is moved to create mass feedback could be an existing part of the phone/apparatus e.g. the battery.

14. Torque-Bar Mass Feedback: for guidance along, through or over boundary's and/or character/word etc selection and/or input through movement of the phone/apparatus in a particular direction (excluding locking and unlocking Security mode).

Torque bar-feedback is mass, example 22a in FIG. 28, that has been moved at a distance along a object 22c and is acted on by gravity 22b as in FIG. 28. The mass that is moved to create mass feedback could be an existing part of the phone/apparatus e.g. the battery.

Accordingly, it will be appreciated that feedback can be optionally provided to the user in a variety of forms.

15. Space and full stop can be included on almost each character key for easier access.

Notably, it will be appreciated that the manufacture and/or user can add virtual pathways. Furthermore, the potential number of characters/virtual access pathways is almost infinite, since the spatial configuration of characters can be like a web or matrix of shelved files or characters. That is, it will be appreciated that there are a variety of planes and directions which can be used by users and/or manufacturers. Additionally, the described system and method herein can provide a solution for more accurate character selection and entry

Some selection and enter actions are activated by a slightly higher than normal g-force movement in a particular direction and can be adjusted by the user to over come confusion to the phone/apparatus on what is asked by the user e.g. when walking and texting etc the sudden movements of your stride may be close to selecting a particular character.

Another way not to confuse the phone/apparatus of the user's actions is to use the dictionary text mode calculating with the movements of the phone/apparatus the probable desired character or a character at all to be selected and or entered.

It will be appreciated that entry of characters can be extremely easy for a number of reasons, most important there is no over run problems in selecting and/or entering characters/words, as there is only one character/word in any particular direction.

Notably, the device can also provide feedback that there is an over-run, where the phone/apparatus is moved or tilted to a particular virtual character/word, in space and over shoots the (target) space to the next character/word.

Generally, most of the characters for standard texting are on the keypad already. Accordingly, it will be appreciated that there are numerous options for the types of sensors that could be used as directional movement input is all that's really needed as illustrated in FIG. 10.

It will be appreciated that the device described herein is not limited to the standard mobile phone keypad, whereas, the qwerty style keypad or any other keypad arrangement or touch screen can be applied. Typing text using the qwerty or other keypad arrangement, allows for the user to type in one or more characters/words, and to continue with selection and entry through movement, as the character/words are displayed around the screen.

Accordingly, a list of the features that can be provided include:
Clock-face: circular segmented arrangement.
Recent/recent alphabetical/common/vocabulary/phrase/words of speech access function
Recent/common sentence access function
Security: create your own virtual path that works like a pin/password for security lock and/or unlock.
: Selection and entry of characters/words/sentences and phrase can both be performed with the press of a key and/or movement of the device in either order or simultaneously in 2D and 3D texting, including but not limited to:
   a) Key selection with virtual Character entry using Virtual 2D texting
   b) Virtual Character selection with key entry using Virtual 2D texting
   c) Key selection with virtual Character entry using Virtual 3D texting
   d) Key entry simultaneously with virtual character selection
   e) Virtual Character selection with key entry using Virtual 3D texting
   f) Character/word/sentence/phrase selection through movement of the phone/apparatus in a particular direction beyond a set virtual selection boundary
   g) Character/word/sentence/phrase enter through movement of the phone/apparatus in a particular direction beyond a set virtual enter boundary
   h) Upper case option after using virtual movements for character selection and entry by using a movement that coincides with enter upper case
   i) Lower case option after using virtual movements for character selection and entry by using a movement that coincides with enter lower case
   j) Upper case character entry option following a virtual character selection and then pressing of a key
   k) Lower case character entry option following a virtual character selection and then pressing of a key
   l) Upper case character entry option following pressing of a key and then virtual character selection
   m) Lower case character entry option following pressing of a key and then virtual character selection
   n) Upper case character entry option following character selection
   o) Lower case character entry option following character selection
   p) High G-force character selection and/or entry
   q) Rotation/tilt selection and/or enter
   r) High speed rotation/tilt selection and/or enter
   s) High speed selection and/or enter through movement in a particular direction
   t) Search mode by holding down a key
   u) Search mode by pressing a key
   v) Search mode by gesture
   w) Search mode by a key double/multi press
   x) Word/sentence mode by a key press
   y) Word/sentence mode by a key hold
   z) Word/sentence mode by a key double/multi press
   aa) Word/sentence mode by a gesture
Feedback through movement of the device and/or press of a key (some examples below but not limited to)
   a) Torque mass feedback
   b) Linear mass feedback
   c) Torque-bar mass feedback
   d) vibrator mass feedback
   e) light feedback
   f) voice feedback
   g) sound feedback
   h) visual feedback
   h) could use battery mass movement as feedback

Advantages of Directional selection or entry as in FIG. 10, 15, 18, 20, 21, 25, 31, 32, 33, 34, 35a/b, 36a/b, 37a/b, 38a/b, 39a/b can include:
a) no overrun problems
b) one movement entry
c) sensor need only sense direction
d) quick character/word/sentence/phrase selection, entry and search
e) no home position required in most cases
Various user options
   a) Customise application program Recent/recent alphabetical/common word/vocabulary or phrases/words of speech access modes
   b) Files: create your own files in your own path.
   c) Manipulate characters around the screen to bring closer together or further apart with the use of a touch screen.
   d) Customise application program holding most used words, names, addresses, etc. to a circular segment arrangement.
   e) 2D and 3D custom virtual pathways can be created
   f) Have an application program holding most used words, names, addresses, etc. to a circular segment arrangement.
Multi-Character Selection: in one virtual path involving two movements.
Dictionary word mode
Calculating virtual movements with dictionary text mode
Space and full stop etc can be included on almost each character key for easier access.
When curser is moved through a sentence over words it can suggest replacement words.
Direction/orientation of the movement that the device is going can be displayed on the screen with eg: an arrow for easier navigation.
Delete functions
Character/word/sentences that haven't been entered can have a transparent appearance in comparison to larger selected character/word.
A feature in user preferences that determines the angle between characters by the number of times the character has been entered eg: a character that has been entered frequently can have a big angle and a character that is entered less frequently can have a small angle.

Accordingly, further examples of the use of the above-described device, system and method are described below.

### Example One

### Recent Alphabetical/Common Word Access, Recent/Common Sentence Access and Dictionary Mode Functions

These functions can be utilised when operating in 2D or 3D virtual texting. Usual selection and entry of characters, as discussed later in this document in the 2D and 3D virtual texting examples, is used in this example along with recent/recent alphabetical/common word access, recent sentence access and the dictionary mode functions as discussed below. The user has the option to operate in search mode by holding down the key while navigating characters and words.

Recent word access function enables access to the most recently used words entered, they are an extension of the character selected, i.e. the first or 2^{nd} letter (character etc) of the word. This function can reduce greatly the number of selections required when text messaging etc, by offering the user the option of selecting words or whole or part of sentences recently used rather than characters. With user preference, this function can also be set to use most common words.

Recent alphabetical word access function may list recently used words in alphabetical order for selection. When recent alphabetical word access function is being used, alphabetical order of the 2^{nd} letter takes preference over most recently used words. The recent alphabetical word access function is a user preference that can greatly reduce the number of selections required when text messaging etc, by offering the user the option of selecting words or whole or part of sentences commonly used rather than characters.

Dictionary word mode suggests the probable desired words etc to be entered, and can be either selected by the user as an option or automatically activated in recent/recent alphabetical/common word access mode after selection of the 2^{nd} or onward character, dependent on user preference.

In search mode: To select a character the user holds down the key that represents the desired character, the character position may be displayed around the perimeter of the screen in a segmented arrangement. The character position on the screen represents the direction for the user to move the device in for selection of the virtual character. The user then releases the key for selection of that character. To use the dictionary or recent/recent alphabetical/common word function, the user continues to hold down the key while navigating to the desired word.

As an advanced user or as a personal preference, the user first moves the phone/apparatus to the desired virtual character (letter)/word without visual guidance until character destination is reached.

Or the user can press the key first that represents the desired character/word and the characters/words may be displayed in a circular segmented arrangement around the perimeter of the screen. The character position on the screen represents the direction for the user to move the device for selection of the virtual character. The user can then select and enter the desired character/word through the usual methods of character selection and entry discussed in examples 2D and 3D virtual texting.

If the user wants to utilise the dictionary, or recent/recent alphabetical/common word access, recent/common sentence access function whilst texting without first initiating recent/recent alphabetical/common word access, recent/common sentence access, the user can move the phone further along the same direction of the desired character to cross a virtual boundary that is acknowledged through feedback to the phone/apparatus. Once the boundary has been crossed, another circular segmented arrangement around the perimeter of the screen may display either the recent word entry function which may consist of most recent words used that begin with the selected letter; or common words used that begin with the selected letter; or a dictionary function which can be activated on the entry of the 2^{nd} or 3^{rd} character of the word being typed in by the user (FIG. 34).

When a word is entered, other words that have been used in a recent/common previous sentence can display themselves around the screen. The user can move the phone/apparatus in the virtual direction that corresponds with the position of the desired word on the display screen and select and/or enter the sentence or edit the sentence by using only the words that are required from a shown existing sentence as in FIG. 40. Access to sentences is not only limited to words that are directly connected to such sentences but also to words related to a chosen letter. For example if the chosen word did not follow on to desired words/sentence, the user does have the option to move towards another word displayed on the screen that the required words could be related to. These are preferences and the user of the phone/apparatus may have the choice on how they access characters/words and sentences using the method they prefer.

### Example Two

### Selecting a Character

All methods of selecting a character can involve mass and/or sound/light/voice feedback for acknowledgement of selection to the user.

Selecting a character is not dependant on the use of pressing a key due to character selection being based on directional movement.
Character selection can occur through movement of the phone/apparatus in a particular direction beyond a set virtual selection boundary with the option of mass and/or sound/light/voice/visual and/or dictionary feedback as acknowledgment to the user that the virtual selection boundary has been crossed, as shown in 16b of FIG. 23.
To select a character in virtual 3D texting using virtual Character selection with key entry: Find the desired character on the key and move beyond the set minimum selection boundary in the desired 3D direction of the virtual character. Once the boundary has been crossed the key can be pressed to enter the character (FIGS. 15 and 16). Mass and/or sound/light/voice/visual and/or dictionary feedback can be activated to acknowledge that the minimum selection boundary has been crossed.
To select a character beyond another character, when character configuration requires such, the user continues to move in the same direction and mass and/or sound/light/voice/visual can alert the user of the boundary between the characters. The user then moves beyond the boundary, as shown in 15b FIG. 22 to select the next character along the path as shown in example 15a. The character is now ready to be entered as an upper or lower-case letter.
A simultaneous movement and press of a key for selection and entry of character.

Selection of upper case or lower case is dependent on the movement that is performed by the phone/apparatus to return to a preset zero mode. When operating in 3D mode up and back to the start point as shown in example 15c in FIG. 22, represents an upper-case letter, or down and back as shown in example 15d, represents a lower-case letter. When operating in 2D mode, the phone is moved in a clockwise or anti-clockwise direction to return to a preset zero mode. As illustrated in FIG. 33 the clockwise movement (2f) may select lower case, and anti-clockwise (2g) may select upper case. Gestures for entering upper case or lower case letters is not limited to the examples demonstrated.

Characters can be selected using a variation of methods such as, but not limited to: directional movement, high speed directional movements; high speed rotation (tilt) selection; high G-force character selection.

The user has the option of pressing the associated key before the phone/apparatus is moved in the direction of the desired character (if key is not released before moving in the desired direction, search mode can be activated); also, the associated key can be pressed after the phone/apparatus has been moved in the desired direction for character selection.

### Example Three

### Entering a Character

All methods of entering a character can involve mass and/or sound/light/voice/visual feedback for enter recognition to the user.

Entering a character is not dependant on the use of an enter key to be pressed for enter recognition due to enter functions based on movement.

To enter a character with the use of a key:

Option 1: Simultaneous movement and press of a key for selection and entry of character.

Option 2: Move in the virtual direction to select the character and then press the key associated with that character to enter.

Option 3: Performed in search mode—press the key associated to the required character, move in virtual direction to select character and then release key to enter.

To enter a character without using the keys:

Option 1: Move beyond the set minimum virtual enter boundary in the desired direction of the virtual character and character may automatically be entered as shown in FIG. 20

Option 2: Move beyond the set minimum virtual boundary in the desired direction of the virtual character then enter the virtual movement that coincides with enter as shown in 13b of FIG. 21.

The example given in 12a of FIG. 20 demonstrates how the user moves the phone/apparatus towards a character 12a, and then moves past a set minimum virtual enter boundary 12b, which enters the character. The user then moves the phone/apparatus to a preset zero mode—up and back to the start point as shown in example 12c, which can represent an upper-case or lower-case letter to be entered.

The example given in 13a of FIG. 21 demonstrates how the user moves the phone/apparatus towards a character, and then moves past a set minimum virtual boundary 13a. The user then enters the virtual movement that coincides with enter as shown in 13b of FIG. 21. The user then moves the phone/apparatus to a preset zero mode—up and back to the start point as shown in example 13c, which can represent an upper-case or lower-case letter to be entered, or down and back which can represents a lower-case letter.

### Example Four

### Search Mode

Search mode can be used in combination with numerous examples described herein, however, it is especially useful when using the method of selecting and/or entry of character/words/sentences and files etc beyond the first character/words etc, as in FIG. 34, and for Virtual 3D texting, where many characters are available on more than one plane. It is also useful for users who are not familiar with the character layout of the phone/apparatus.

The search mode is important for learning about the phone/apparatus and also for character recognition of non-English character sets where there may be many (e.g. 24) standard characters per key. However, the potential number of characters is almost infinite, since the spatial configuration of characters can be like a web or matrix of shelved files or characters. The search mode function can also be used for the selection and entry of characters/words, files etc, and can be used for people who are not familiar with the character layout of the phone/apparatus.

The first example given here is how to use search mode in a selection and enter method when using Virtual Basic 2D texting.

To search for characters/words/sentences and files etc hold e.g. [5jkl] key down and characters that are linked to that key from the home position can be displayed. The user then moves the phone/apparatus in the direction of the required virtual character and selection of that character can occur by releasing the key, or if the key is continued to be held the character/words/sentences and files etc linked to those character/words/sentences or files etc, as in FIG. 34 can be displayed. The user then moves the phone/apparatus in the direction of the required character/word/sentence/phrase or file, and selection of the character/word/sentence/phrase or file can occur by releasing the key; or by using a virtual movement that coincides with enter; or with a move beyond the set minimum virtual enter boundary of selected character. By using the movement that coincides with enter option, while key is continuously held down, selection of more than one word can be entered.

The second example given here is how to use the search mode in another selection and enter method when using Virtual Advanced 2D texting.

To search for a character (or file) hold e.g. [1abc] key down. While the key is pressed, navigation to many destinations with the option of mass and/or sound/light/voice/visual feedback to access the required character can be performed. Once the character has been identified on the display screen and/or through feedback, selection of that character can occur when the key is released, or with a virtual movement that coincides with enter, or with a move beyond the set minimum virtual enter boundary of selected character.

Similar steps, as shown in the second example in reference to Virtual Advanced 2D texting can be used for navigating to a multitude of available destinations for character selection on more than one plane, as illustrated in FIGS. 15, 16 and 18.

To use search mode without having to press a key, a virtual movement that activates the search mode can be used (a virtual command that holds the key). When wanting to use the search mode for character selection for texting, once the user has activated the search mode and moved beyond the set minimum boundary in the desired direction of the virtual character, then a virtual movement that coincides with enter can select the character. Alternatively, the character can be selected via a move beyond a set minimum virtual enter boundary.

### Example Five

### Custom Virtual Security Lock and/or Unlock

Customary virtual pathways that work like a pin/password for access to lock and/or unlock phone/apparatus or phone features can be created.

To set up a virtual security lock and/or unlock the user performs one or a multitude of different movements and enters by pressing a key or using a virtual movement that the user has set for enter recognition.

A different movement/virtual pathway may be set for unlocking to locking.

The virtual pathway (9a in FIG. 17) chosen for the security lock and/or unlock can be set after the first pathway has been logged, or the user may choose to repeat the pathway a number of times to average the perimeter (tunnel extent—9b) of the logged pathway. This option to average the perimeter (boundary extent) enables enough scope so the user can set a pathway that suits their ability to accurately repeat the action.

boundary perimeters can be set by the manufacturer and/or user. setting of boundary extents (perimeters) can apply to all virtual paths.

Enter extent perimeters—9c in FIG. 17, can be set by the manufacturer and/or user.

To activate the security lock and/or unlock the user can press a chosen key (or a combination of keys) and then do the virtual movement and release the key.

Security lock and unlock can also be activated without the use of keys. Virtual movements can be created to activate the phone in recognition that the user requires to use the security function.

### Example Six

### Virtual Basic 2D Texting

1. Virtual 2D texting can be set by user and/or manufacturer in an x, y or z plane.
2. The character location (e.g. replace (A) with (a)) can be set by manufacture and/or user.
3. Manufacture and/or user can modify the length of recognition of direction.
4. The length of recognition of enter of character can be modified by manufacture and/or user.
5. To Enter a Character: move beyond the set minimum virtual boundary in the desired direction of the virtual character and press the key representing the character to enter.
6. To Enter a Character Without Using the Keys: move beyond the set minimum virtual boundary in the desired direction of the virtual character then enter the virtual movement that coincides with enter.
7. To Enter a Character Without Using the Keys: move beyond the set minimum virtual enter boundary in the desired direction of the virtual character and character may automatically be entered.
8. To Enter Character Using Search Mode: hold down the key that represents the desired character, then move beyond the set minimum virtual boundary in the desired direction of the virtual character, then release the key.
9. To Enter Character Using Search Mode: hold down the key that represents the desired character, then move beyond the set minimum virtual enter boundary in the direction of the virtual character and character may automatically be entered. This option gives the advantage to select any number of characters that are linked to that held key.

An example shown as 1a in FIG. 10 is the selection of the character ‘a’ showing movement of the phone/apparatus parallel to the keypad face in a direction for selection of the character. In this case the phone/apparatus is moved to the left.

An example of how the user enters the text ‘12 September 2007’ using the alphanumeric data input keypad FIG. 13 through the selection of characters using directional movements parallel to the keypad face as illustrated in FIG. 10 may now be demonstrated with reference to FIGS. 10 and 12.

Key selection and enter can also be virtual selections/enters without the requirement of the press of any key, however in this example the press of a key is used. Points 5-9 above are different examples of how selection and enter can be performed and can apply to the following example of 2D texting.

Firstly, to select a numerical character, in this case ‘1’ no motion is required as selection of numerals is the neutral position in reference to the phone in FIG. 10. While phone is in neutral position the user presses the [1] key once and then releases. To select the numerical character ‘2’ in reference to FIG. 10 the same applies as in selection of ‘1’ with the phone in neutral position and the user presses the [2abc] key once and then releases.

Next, to enter a blank space, the user makes a downward motion with the phone parallel to the keypad face and then, in this example, presses the [2abc] key once and releases. The space function can also be accessed with the same movement on the following keys: [3def], [4ghi], [5jkl], [6mno] and [8tuv].

To select an upper-case ‘S’ in reference to FIG. 10, the user moves the phone diagonally in one movement down and across to the right, presses the [7pqrs] key once and releases. All upper-case alphabetic character selections may be a diagonal movement of the phone parallel to the keypad face. For those keys that have only three alphabetical characters have a full stop function available in this position.

To select ‘e’ the user makes an upward motion with the phone parallel to the keypad face, presses [3def] key once and releases. All lower-case alphabetic characters selections are selected with a clockwise movement of the phone parallel to the keypad face, returning the phone to a preset zero.

To select ‘p’ the user moves the phone parallel to the keypad face to the left, presses the [7pqrs] key once and releases.

To select ‘t’ the user moves the phone parallel to the keypad face to the left, presses [8tuv] key once and releases.

To select ‘e’ the user makes an upward motion with the phone parallel to the keypad face, presses [3def] key once and releases.

To select ‘m’ the user moves the phone parallel to the keypad face to the left, presses [6mno] key once and releases.

To select ‘b’ the user makes an upward motion with the phone parallel to the keypad face, presses [2abc] key once and releases.

To select ‘e’ the user makes an upward ward motion with the phone parallel to the keypad face, presses [3def] key once and releases.

To select ‘r’ the user moves the phone parallel to the keypad face to the right, presses [6mno] key once and releases.

To enter a blank space, the user makes a downward motion with the phone parallel to the keypad face and then, in this example, presses the [2abc] key once and releases.

To select the numerical character ‘2’ in reference to FIG. 10 no movement of the phone is required maintaining a neutral position, user presses the [2abc] key once and releases. The same neutral position applies for selection of ‘0’, user presses the [0] key once and releases, and ‘7’, user presses the [7pqrs] key once and releases.

To select a full stop the user moves the phone diagonally in one movement down and across to the right, presses the [2abc] key once and releases. The full stop function can also be accessed with the same movement on the following keys: [3def], [4ghi], [5jkl], [6mno] and [8tuv].

### Example Seven

### Virtual Advanced 2D Texting

In this seventh example, access is allowed to more characters based on more directional moves. As illustrated in FIG. 34, more movements for character selection is available than in the sixth example as illustrated in FIG. 10. The seventh example has repeats of the same directional moves following on from the first set of directional moves of the sixth example.

Points 1 to 9 in the operations of the sixth example—Virtual Basic 2D texting, also apply to the operations of this seventh example—Virtual Advanced 2D texting.

FIG. 34 illustrates the selection of characters then words and sentences of the seventh example.

Example 5a in FIG. 34 is the selection of the word ‘about’ with movement of the phone/apparatus parallel to the keypad face in a direction for selection of the character. In this case the phone/apparatus is moved consecutively to the left, down and diagonally towards the left.

Key selection and enters can also be virtual selections/enters without the requirement of the press of any key.

To select an alphabetical character, the user moves the phone parallel to the keypad face to and presses a key once. At this point recent/recent alphabetical/common words that start with with the character selected may be displayed on the screen. The user can select one of these words, however, if the word the user requires is not there then the second letter can be entered and the screen may be refreshed with new words that start with the first letter and follows with the second letter.

If the word is still not present, dictionary mode is activated if this preference is switched on and set to third letter to override the recent/recent alphabetical/common words access function.

### Example Eight

### Virtual 3D Texting

Virtual 3D texting is useful for languages that have word characters (e.g. Chinese) because there can be many (e.g. 24) standard characters per key. The potential number of characters is almost infinite, since the spatial configuration of characters can be like a web or matrix of shelved files or characters—see FIGS. 15, 16, and 18.

Points 2 to 9 in the operations of the sixth example—Virtual Basic 2D texting, also apply to the operations of this eighth example—Virtual 3D texting.

To select and enter characters for the Virtual 3D texting the same steps are used as given in the examples in the operations in the sixth and seventh examples (Virtual Basic 2D and Virtual Advanced 2D texting) with the only difference that being the multitude of movements in more than one plane.

Virtual 3D texting can be accessed via the Virtual 2D texting. When the user is in 2D texting they can either press an allocated key, or use a created virtual movement, to access the 3D texting application. Once this application has been accessed, navigation just by simple movement of the phone/apparatus enables finding and selection of characters from a multitude of levels and directions.

How to Access Multiple Levels—the user moves in the direction towards the desired plane and hits enter, or virtual movement that coincides with enter, to take them to the next level. It is like a multi-story building where there are many levels and the character sets can be assigned to the levels for easy navigation. Eg: each level could be numbers, letters or non-language characters, as in FIG. 18

Once the 3D texting has been activated, access to other levels does not require a key to be pressed for entering the next level. This is useful when the user is e.g. on level one and wants to next select a character on level 10. Therefore, the necessity to press the key between each level is avoided which in turn creates quicker and easier character selection. However, a key or virtual movement can be used to lock in on each level if user desires.

### Example Nine

### Boundary Mass and/or Sound/Light/Voice/Visual and/or Dictionary Feedback

It will be appreciated that the mass feedback can be the battery of the device, although it is not limited to this. Different types of feedback can be available to acknowledge different selection/enter of characters/words/sentences or files etc.

Mass and/or sound/light/voice/visual feedback mode gives the virtual boundaries a physical appearance in all examples described above excluding (in one particular example) locking and unlocking of Security mode.

Example 1b and 1c of FIG. 10 are boundaries that can be activated for mass and/or sound/light/voice/visual feedback e.g. movement of mass in phone/apparatus.

The use of boundary mass and/or sound/light/voice/visual feedback to the phone/apparatus through the movement of mass in the phone/apparatus (as in a game console joy stick, or the vibration device as used in a phone) may help assist navigation through virtual paths to character/word/sentence/phrase or file destination, although it is not necessary for this to occur. Accordingly, it is not required for all actions to be visually displayed on the device.

When navigating through virtual pathways the phone can give feedback to the user through movement of mass in the phone/apparatus. If the user is veering off the virtual pathway the phone/apparatus may simulate a collision into a boundary with linear, torque, torque-bar or vibrational feedback to the phone/apparatus. Notably. other types of feedback can notify the user of these boundaries, for example, voice feedback, or the like.

In example 15b in FIG. 22 when the user wants to select a character beyond a character, mass/sound/light and/or voice feedback can alert the user of character selection or border boundaries.

It will be appreciated that feedback of the phone/apparatus, simulating boundary collision as it is navigating through virtual paths, can make the phone/apparatus user friendly for the sight impaired. For example, through memorising a certain pattern of characters or virtual pathways/directions it is not necessary for the user to see where they are going if they can feel or hear where they are going.

### Example Ten

### Gaming Mode

The idea of the interactive aspect of this invention can be used for gaining eg: a score can be given for the time it takes to write/send text message. When texting in gaming mode there can be interaction between the user of the mobile device and a text gaming program. In a simple form the user of a phone may press a key eg: [2abc] and the characters linked to that key are displayed around the screen. A maze appears on the screen and the user is required to work through the maze to get to the desired character. This can be done by either direction and/or tilt and/or rotate of the device, or with a touch screen

.Interactive selection/entry of characters/words etc can be performed using directional movement/tilt/rotation or a touch screen. eg: a bow and arrow is pointed towards the character by movement or touch and the arrow can be released by moving in the direction of the character. The arrow moves in the direction of the character/word etc and for example the character can explode. After explosion of the character, it is entered into the text area. The explosion of the character gives feedback that the character has been entered. This feedback can be both visual and vibration for example. Another example is having a cartoon person on running around on the screen grabbing characters.

Another example for gaming mode using the interactive feature can be the user of the device chases the desired character through tunnels, over hills etc. Once the character is caught the character can give you new characters/words/sentences.

The idea of the interactive text gaming is not limited to the above mentioned example formats. There can be a multitude of ways of accessing, selecting and entering characters/words/sentences/part of sentences or phrases with directional movement/tilting/rotating of a device or touch of a screen/joystick/keyboard or mouse. The functions that are available in the main patent are made available in the game.

Thus, in this particular example, moving the select area around the screen interactively by dragging the character (select area) with your finger on the screen. The process is not limited to the standard mobile phone keypad, whereas, the qwerty style keypad or any other keypad arrangement can be applied. Typing text using the qwerty or other keypad arrangement, allows for the user to type in one or more characters/words, and to continue with selection and entry through movement, as the character/words are displayed around the screen. Furthermore, the process can include a delete functions—delete can be performed similar to selection/entry through the movement of the device; be that directional, rotational, tilting or shake etc or by just by pressing a key. Notably, the character/word/sentences that haven't been entered can have a transparent appearance in comparison larger selected character/word.

### Example Eleven

### Interactive Mode

Placement of characters/words can be repositioned around the screen through the interactive mode. Eg: putting finger on the character and dragging it to a new position. Rearrangement of characters/words enables the introduction of more characters/words as the characters/words already on the screen are bunched closer together or taken away. This can be set to suit the users preferences. Angles between the characters can be changed by this method also.

The interactive mode can also enable shuffling through characters/words/sentences etc. Eg: holding finger on a particular character/word and dragging around the screen in a clockwise direction can introduce new character/words onto the screen as old/character words go out.

Thus, interactive selection/entry of characters/words etc can be performed using directional movement/tilt/rotation or a touch screen eg: a bow and arrow is pointed towards the character required by movement or touch and the arrow can be released. The arrow moves in the direction of the character/word etc and for example the character can explode. After explosion of the character, it is entered into the text area. The explosion of the character is feedback that the character has been entered. This feed back can be both visual and vibration/sound for example. The idea of the interactive aspect of this invention can be used for gaming eg: a score can be given for the for the time it takes to send text message.

Additionally, the placement of the characters/words can be repositioned around the screen through the interactive mode. Eg: putting finger on the character and dragging it to a new position. Rearrangement of characters/words enables the introduction of more characters/words as the characters words already on the screen are bunched closer together or taken away.

Thus, it will be appreciated that the system/process described herein can make it easier, and more enjoyable to enter text, words, sentences with guidance along and over (through) virtual paths, and/or with directional feedback, as well as with acknowledgement by feedback to the user of the device. Additional functions described herein include a search mode and security lock function using the virtual pathways.

Thus, according to one particular example, the selection of characters/words/sentences, and the creation of virtual pathways, can all occur through pressing of a key/touch screen (by styles etc) and/or movement of the device using at least one sensor that senses the accelerated movement of the device.

Furthermore, the movement can be in the three-dimensional space (X, Y, Z planes). Therefore, this can provide numerous different virtual access pathways. Additionally, a user can also create their own pathways.

Accordingly, the device described herein can provide numerous features including a clock face arrangement around the screen, character selection and entry without pressing keys, the creation of customary virtual pathways that work like a pin/password for access to lock and/or unlock phone/apparatus, and feedback (e.g. vibration) of the device (e.g. mobile phone) simulating boundary collision as it is navigating through virtual paths, which can make the device user friendly for the sight impaired. The device (e.g. mobile phone) can also provide feedback acknowledging selection AND entry of a character/word etc. Another feature includes preset or customary movements for selection or entry of upper or lower case characters.

Furthermore, the device can provide Selection/entry of characters/words/sentences/phrases through directional movement of the device; Selection/entry of characters/words/sentences/phrases through tilting/rotating the device; Selection/entry of word/s from commonly/recently used words or a dictionary in relation to previously entered character; Selection/entry of word/s from commonly/recently used words or a dictionary in relation to previously entered word; Selection/entry of a word/s from commonly/recently used sentence in relation to previously entered word; Selection/entry of words from a theme in relation to previously entered word; Selection/entry of words from a phrase in relation to previously entered word; Selection/entry of words from words of speech in relation to previously entered word; Selection/entry of a common/recent/likely character in relation to the previously entered word; Selection/entry of a common/recent/likely word in relation to the previously entered sentence or part thereof; Sentence selection through previously entered character/word or sentence; Theme, phrase, words of speech selection through previously entered character/word or sentence.

Additionally, if a curser is moved through a sentence over words, then the device may suggest replacement words, and further still, direction/orientation of the movement that the device is going can be displayed on the screen with eg: an arrow showing direction for easier navigation.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

1. A method for causing an action to be performed in a device, the method including the steps of, in a processing system of the device:
a) receiving an indication of movement of at least a portion of the device, the movement being associated with an action option; and,
b) causing the action to be performed in respect of the movement.

2. The method of claim 1, wherein the method includes:
a) displaying a plurality of action options; and,
b) receiving the indication of movement in a direction of at least one of the plurality of action options.

3. The method of claim 2, wherein the method includes receiving an indication of a selection of the at least one of the plurality of action options.

4. The method of claim 3, wherein the indication of the selection of the at least one of the plurality of action options includes at least one selected from the group consisting of:
a) a predetermined movement;
b) crossing of a virtual boundary;
c) pressing of a key of the device; and,
d) releasing of a key of the device.

5. The method of claim 3, wherein the method includes generating a feedback in accordance with the received indication of selection.

6. The method of claim 5, wherein generating a feedback includes at least one selected from the group consisting of:
a) vibration of the device;
b) a visual feedback; and,
c) an auditory feedback.

7. The method of claim 2, wherein the method includes displaying the plurality of action options in a display of the processing system, the plurality of action options being angularly spaced apart from each other.

8. The method of claim 7, wherein the method includes displaying the plurality of action options around a circle or a clock-face arrangement around the display.

9. The method of claim 7, wherein the method includes displaying the plurality of action options along a path.

10. The method of claim 7, wherein the display of the plurality of action options is predetermined.

11. The method of claim 1, wherein the action option includes at least one selected from the group consisting of:
a) text selection;
b) character selection;
c) sentence selection;
d) mode selection; and,
e) operational/functional selection.

12. The method of claim 1, wherein the indication of movement includes at least one selected from the group consisting of:
a) indication of device movement according to a three-dimensional space;
b) indication of device movement in an angled directional movement;
c) indication of tilting of the device; and,
d) indication of rotating of the device.

13. The method of claim 1, wherein the device is at least one selected from the group consisting of:
a) a hand-held device;
b) a mobile telecommunication device (phone);
c) a digital organiser;
d) a Personal Digital Assistant (PDA); and,
e) a digital music player.

14. A device, the device being configured to perform an action, the device including a processing system, the processing system being configured to:
a) receive an indication of movement of at least a portion of the device, the movement being associated with an action option; and,
b) cause the action to be performed in respect of the movement.

15. (canceled)
